(19) United States
(12) Patent Application Publication
(10) Pub. No.: US 2001/0033443 A1
(43) Pub. Date: Oct. 25, 2001

(54) Large capacity disk drive

(75) Inventor: Hidetoshi Kabasawa, Saitama-ken (JP)

Correspondence Address: ANDERSON KILL & OLICK, P.C., 1251 Avenue of the Americas, New York, NY, 10020, US

(73) Assignee: TEAC Corporation

(21) Appl. No.: 09/780,214

(22) Filed: Feb. 9, 2001

Related U.S. Application Data
(63) Continuation of application No. 09/265,609, filed on Mar. 10, 1999, now abandoned.

(30) Foreign Application Priority Data
Mar. 12, 1998 (JP) 10-61610
Oct. 29, 1998 (JP) 10-309103

(51) Int. Cl. G11B 5/55

(52) U.S. Cl. 360/6; 360/266.7; 360/266.6; 360/266.5

(57) ABSTRACT

A disk drive includes a head carriage movable in a radial direction of a disk mounted on the disk drive, a guide rod fixed on a frame of th disk drive for guiding the head carriage, a voice coil motor including a magnetic circuit screwed on the frame and a drive coil mounted on the head carriage, a guide-rod catching member provided on the frame so as to catch the guide rod, and a resilient guide-rod urging member resiliently urging the guide rod against the guide-rod catching member, wherein the resilient guide-rod urging member is screwed on the frame together with the magnetic circuit.

### BACKGROUND OF THE INVENTION

The present invention generally relates to disk drives and more particularly to a floppy disk drive having a very large storage capacity.

Floppy disk drives are used extensively in computers and other information processing apparatuses as a removable storage device.

A floppy disk drive generally holds a floppy disk accommodated in a disk cartridge in a manner removable to and from the floppy disk drive and includes a driving mechanism that causes a rotation in the floppy disk thus held in the floppy disk drive. Further, a floppy disk drive includes a magnetic head that makes a sliding contact with the rotating floppy disk.

In order to hold a floppy disk removably, a floppy disk drive generally includes a disk holder adapted to accept a floppy disk cartridge removably and a slider for moving the disk holder from an insertion/ejection position to a mounting position in response to the insertion of the disk cartridge into the disk holder. In correspondence to the movement of the disk holder, the floppy disk cartridge in the disk holder is moved from an unloading position to a loading position. Further, by pressing an ejection button generally provided at the front edge of the slider, the disk holder is moved from the mounting position to the insertion/ejection position and the disk cartridge is moved from the loading position to the unloading position.

In such a construction, the slider is urged in a predetermined direction by a spring in a state that the slider is held by a latch lever against the urging force of the spring, while the latch lever is constructed to rotate in response to the insertion of the disk cartridge into the floppy disk drive. In response to the rotation of the latch lever, the slider is released and is moved to the mounting position. Associated with the movement of the slider, the disk holder is lowered from the unloading position to the loading position and the floppy disk in the disk cartridge is mounted on a turntable driven by a spindle motor.

In such conventional floppy disk drives, there is an urging demand for increased storage capacity particularly in relation to storage of various audio and visual information data. In order to meet for such a demand of increased storage capacity, efforts are being made to increase the rotational speed of the floppy disk in the floppy disk drive, wherein such large-capacity floppy disk drives use a floating magnetic head rather than conventional magnetic head that makes a sliding contact with the rotating floppy disk. In a floating magnetic head, the magnetic head is floated from the surface of the rotating floppy disk by an air foil, wherein such a floating magnetic head is generally driven not by a conventional head carriage mechanism using a lead screw mechanism but by a head carriage mechanism using voice coil motor.

FIGS. 1A and 1B show the construction of a head carriage mechanism 10 that uses a voice coil motor for driving a head carriage 11.

Referring to FIGS. 1A and 1B, the head carriage 11 carrying a magnetic head 12 thereon is held by a pair of guide rods 15 and 16 so as to be movable in a radial direction, or Y₁-Y₂ directions, of a rotating floppy disk 17, wherein the head carriage 11 is driven by a pair of voice coil motors 13 and 14 disposed at respective sides of the head carriage 11. In the illustrated state, the floppy disk 17 is coupled to a turntable 18 and is rotated by a spindle motor 30 driving the turntable 18. The voice coil motor 13 includes a magnetic circuit structure 20 and a driving coil 21, while the voice coil motor 14 includes a magnetic circuit structure 22 and a drive coil 23.

The foregoing head carriage mechanism 10 is mounted on a frame 25 on which the spindle motor 30 is mounted. It should be noted that the guide rod 15 is mounted on the frame 25 at both longitudinal ends thereof by screws 31 and 32, while the guide rod 16 is mounted on the frame 25 at both longitudinal ends thereof by screws 33 and 34. Further, the magnetic structure 20 is mounted on the frame 25 at both longitudinal ends thereof by screws 35 and 36, while the magnetic structure 22 is mounted on the frame 25 at both longitudinal ends thereof by screws 37 and 38.

In the conventional construction of FIGS. 1A and 1B, in which the guide rods 15, 16 and the magnetic circuit structures 20, 22 are mounted on the frame 25 separately by respective screws, it has been necessary to conduct eight screwing steps for assembling the head carriage mechanism 10 on the frame 25, while such a large number of screwing steps is disadvantageous for reducing the cost of the floppy disk drive. Further, the construction of FIGS. 1A and 1B requires a space when conducting the screwing process for accommodating the screw head and screw tap, while such a space is disadvantageous for reducing the side of the floppy disk drive.

Further, the conventional head carriage mechanism 10 has suffered from the problem of possible damage to the head carriage caused by a seek error. When there occurs a seek error during such a seek operation of the head carriage 11, the head carriage 11 may move beyond the area of nominal movement thereof and collide with the yoke of the voice coil motor 13 or 14.

### SUMMARY OF THE INVENTION

Accordingly, it is a general object of the present invention to provide a novel and useful disk drive wherein the foregoing problems are eliminated.

Another and more specific object of the present invention is to provide a disk drive, comprising:

a frame;

a rotatable turntable adapted to support a disk;

a head carriage movable in a radial direction of said disk in a state that said disk is held on said turntable;

a head provided on said head carriage, said head conducting writing or reading of information to and from said disk;

a guide rod fixed on said frame so as to guide said head carriage;

a voice coil motor including a magnetic circuit screwed on said frame and a drive coil mounted on said head carriage, said voice coil motor causing said head carriage to move in said radial direction of said disk;

a guide-rod catching member provided on said frame so as to catch said guide rod; and

a resilient guide-rod urging member screwed on said frame together with said magnetic circuit, such that said guide-rod urging member resiliently urging said guide rod against said guide-rod catching member.

According to the present invention, the guide-rod urging member is screwed on the frame together with the magnetic circuit. Thus, the number of the screwing steps is reduced as compared with the case of screwing the magnetic circuit and the guide-rod urging member individually. Thereby, the cost of assembling the magnetic disk drive is reduced. Further, the present invention requires a smaller space for the screwing operation in correspondence to the reduced number of the screws, and the disk drive of the present invention can be formed with a reduced size. It should be noted that the guide-rod urging member absorbs any error in the mounting of the magnetic circuit on the frame. Thereby, the mounting of the magnetic circuit on the frame can be made with a relatively low precision, and the cost of the disk drive is reduced.

Another object of the present invention is to provide a disk drive, comprising:

a frame;

a rotatable turntable adapted to support a disk;

a head carriage movable in a radial direction of said disk in a state that said disk is held on said turntable;

a head provided on said head carriage, said head conducting writing or reading of information to and from said disk;

a guide rod fixed on said frame so as to guide said head carriage;

a voice coil motor including a magnetic circuit screwed on said frame and a drive coil mounted on said head carriage, said voice coil motor causing said head carriage to move in said radial direction of said disk;

a guide-rod catching member provided on said frame so as to catch said guide rod; and

a resilient guide-rod urging member having a part adapted to be mounted on said magnetic circuit, said resilient guide-rod urging member being mounted on said magnetic circuit such that said guide-rod urging member resiliently urges said guide rod against said guide-rod catching member,

said magnetic circuit being screwed on said frame in a state that said guide-rod urging member is provided on said magnetic circuit.

According to the present invention, the guide-rod urging member is mounted on the magnetic circuit and the magnetic circuit is screwed on the frame. Thereby, the efficiency of assembling the head carriage and the voice coil motor is improved further.

Another object of the present invention is to provide a disk drive, comprising:

a frame;

a rotatable turntable adapted to support a disk;

a head carriage movable in a radial direction of said disk in a state that said disk is held on said turntable;

a head provided on said head carriage, said head conducting writing or reading of information to and from said disk;

a guide rod fixed on said frame so as to guide said head carriage; and

a voice coil motor including a magnetic circuit screwed on said frame and a drive coil mounted on said head carriage, said voice coil causing said head carriage to move in said radial direction of said disk;

said magnetic circuit having a guide-rod holding part holding said guide rod,

said magnetic circuit being screwed on said frame in the state that said magnetic circuit holds said guide-rod at said guide-rod holding part.

According to the present invention, in which the guide rod is held at the guide-rod holding part of the magnetic circuit, the step of mounting the guide rod on the frame can be eliminated, and hence the corresponding screwing steps. Thereby, the assembling of the disk drive is achieved easily.

Another object of the present invention is to provide a disk drive, comprising:

a frame;

a rotatable turntable adapted to support a disk;

a head carriage movable in a radial direction of said disk in a state that said disk is held on said turntable;

a head provided on said head carriage, said head conducting writing or reading of information to and from said disk;

a voice coil motor causing said head carriage to move in said radial direction of said disk within a predetermined range; and

a deformable shock absorber disposed in the vicinity of a said predetermined range, said deformable shock absorber being disposed so as to collide with said head carriage when said head carriage is moved beyond said predetermined range.

According to the present invention, the problem of damage to the head carriage is reduced substantially in such a case in which the head carriage has accidentally moved beyond the predetermined range.

Other objects and further features of the present invention will become apparent from the following detailed description when read in conjunction with the attached drawings.

### BRIEF DESCRIPTION OF THE DRAWINGS

FIGS. 1A and 1B are diagrams showing the construction of a conventional floppy disk drive;

FIG. 2 is a diagram showing the construction of a disk drive according to a first embodiment of the present invention in an exploded view;

FIGS. 3A-3C are diagrams showing the disk drive of the first embodiment in a plan view, front view and a side view;

FIG. 4 is a diagram showing a head carriage and a voice coil motor used in the disk drive of the first embodiment in an exploded view;

FIG. 5 is a diagram showing the head carriage and the voice coil motor in a plan view;

FIG. 6 is a cross-sectional view of the disk drive of the first embodiment along a line V-V of FIG. 5;

FIG. 7 is a diagram showing the disk drive of the first embodiment along a line VI-VI of FIG. 5;

FIG. 8 is a diagram showing the disk drive of the first embodiment along a line VII-VII of FIG. 5;

FIG. 9 is a diagram showing the head carriage and the voice coil motor in an oblique bottom view;

FIGS. 10A-10D are diagrams showing the construction of a magnetic circuit used in the disk drive of the first embodiment;

FIGS. 11A-11C are diagrams showing the construction of a guide-rod urging member used in the disk drive of the first embodiment;

FIGS. 12A-12C are diagrams showing the construction of another guide-rod urging member used in the disk drive of the first embodiment;

FIG. 13 is a diagram showing the construction of a further guide-rod urging member used in the disk drive of the first embodiment;

FIG. 14 is a diagram showing the construction of a further guide-rod urging member used in the disk drive of the first embodiment;

FIGS. 15A and 15B are diagrams showing the construction of a disk drive according to a second embodiment of the present invention;

FIG. 16 is a diagram showing the construction of a disk drive according to a third embodiment of the present invention in a plan view in the state prior to insertion of a disk cartridge;

FIG. 17 is a diagram showing the construction of the disk drive of the third embodiment in a plan view in the state after a disk cartridge is mounted;

FIGS. 18A and 18B are diagrams showing an automatic ejection mechanism used in the disk drive of the third embodiment in an enlarged view;

FIG. 19 is a diagram showing the general construction of the disk drive of the third embodiment in an exploded view;

FIG. 20 is a diagram showing the general construction of a head carriage mechanism used in the disk drive of the third embodiment in an exploded view;

FIG. 21 is a diagram showing the disk drive of the third embodiment in a front view;

FIG. 22 is a diagram showing the construction of a disk insertion/ejection mechanism used in the disk drive of the third embodiment in a side view;

FIG. 23 is a diagram showing a head carriage lock mechanism used in the disk drive of the third embodiment in a plan view with an enlarged scale;

FIG. 24 is a diagram showing the construction of the head carriage lock mechanism of FIG. 23 in an exploded view;

FIG. 25 is a diagram showing the construction of a head carriage and related parts used in the disk drive of the third embodiment in an exploded view;

FIG. 26 is a diagram showing the construction of a pressing member in an oblique view with an enlarged scale;

FIG. 27 is a diagram showing the relationship between a rear base part of a carriage main body and a corresponding supporting part used in the disk drive of the third embodiment in a plan view; and

FIG. 28 is a diagram showing the relationship between the rear base part and the supporting part of FIG. 27 in the state that the rear base part is contacted with the supporting part.

### DETAILED DESCRIPTION OF THE PREFERRED EMBODIMENTS

[First Embodiment]

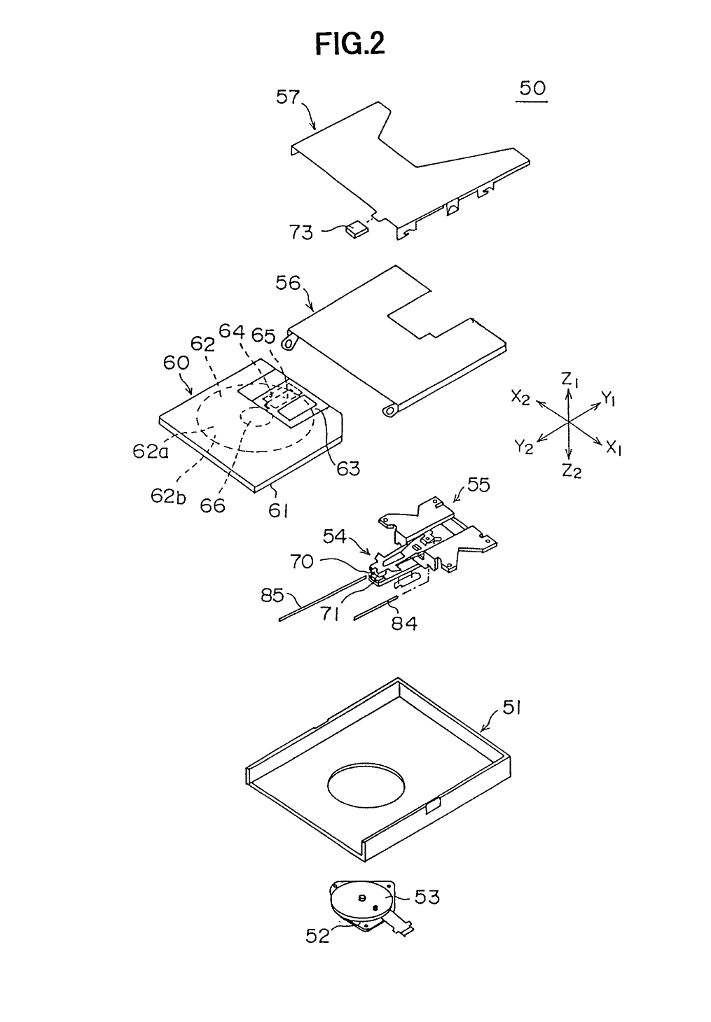

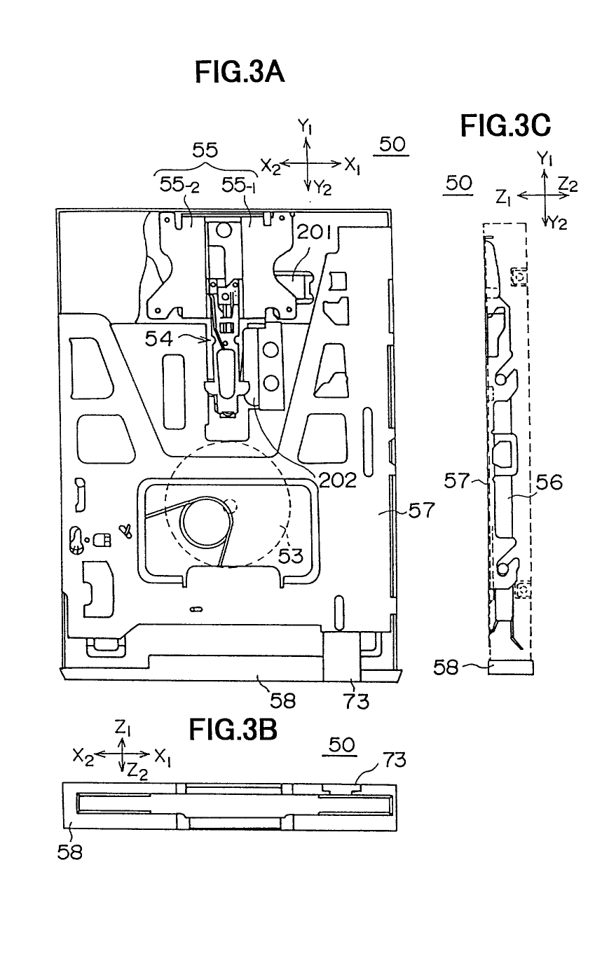

FIG. 2 and FIGS. 3A-3C show the construction of a floppy disk drive 50 according to a first embodiment of the present invention.

Referring to the drawings, the floppy disk drive 50 is a large-capacity device and includes a frame 51 on which a motor 52 and a turntable 53 driven by the motor 52 are mounted. Further, the disk drive 50 includes a head carriage 54 and a voice coil motor 55 cooperating with the head carriage 54 in the state that the voice coil motor 55 is mounted on the frame 51, and a holder 56 and a slider 57, which acts also as a top plate, are disposed above the head carriage 54. Further, the floppy disk drive 50 includes a front bezel 58. See FIG. 3B.

The floppy disk drive 50 uses a disk cartridge 60 wherein the disk cartridge 60 includes a cartridge main body 61 that accommodates therein a floppy disk 62 having a diameter of 3.5 inches. Further, the cartridge 60 carries a shutter 63 on the side wall of the cartridge body 61, such that the shutter 63 covers openings 64 and 65 formed respectively at the top surface and bottom surface of the cartridge body 61. Further, the floppy disk 62 has a hub 66 exposed at the bottom surface of the cartridge body 61.

When the disk cartridge 60 is inserted into the disk drive 50 through the front bezel 58 in the Y₁-direction represented in FIG. 2, the disk cartridge 60 is accepted into the holder 56, and the shutter 62 is caused to slide in the X₂-direction to expose the foregoing openings 64 and 65. In this state, a lower magnetic head 71 faces the lower opening 65 and an upper magnetic head 70 faces the upper opening 64.

Next, the lock of the slider 57 is released, and the slider 57 undergoes a slide movement in the Y₁-direction, wherein the foregoing lateral movement of the slider 57 causes a simultaneous downward movement of the holder 56, together with the disk cartridge 60 therein, in the Z₂-direction. As a result of the downward movement of the holder 56, the hub 66 of the floppy disk 62 is coupled with the turntable 53. Further, the lower magnetic head 71 makes a contact with a lower surface 62b of the floppy disk 62 as a result of the foregoing downward movement of the disk cartridge 60.

Next, the motor 52 is energized and the floppy disk 62 is rotated at a speed of about 3600 rpm. Further, a solenoid 201 of FIG. 3A is energized and a lift arm 202 undergoes a downward movement by a head loading mechanism not illustrated. As a result of this, the upper magnetic head 70 is lowered together with the lift arm 202, and the upper magnetic head 70 makes a landing on the top surface of the floppy disk 62 at the opening 64. The head carriage 54, in turn, is moved in the Y₁-Y₂-directions by the voice coil motor 55. Thereby, reading and writing of information signal is made by any of the magnetic heads 70 and 71 with a track density of 2000-3000 TPI in the state that the magnetic heads 70 and 71 are floating from the surface of the floppy disk 62.

When the eject button 73 is pressed, on the other hand, the disk cartridge 60 is moved in the Z₁-direction, followed by a movement in the Y₂-direction. Thereby, the disk cartridge 60 is ejected from the disk drive 50.

Hereinafter, the head carriage 54 and the voice coil motor 55 will be described.

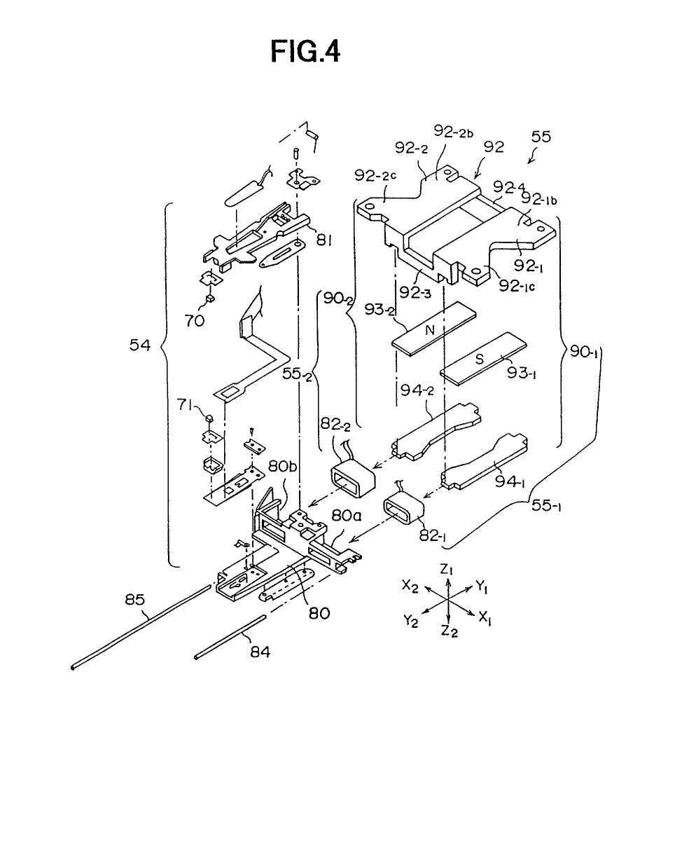

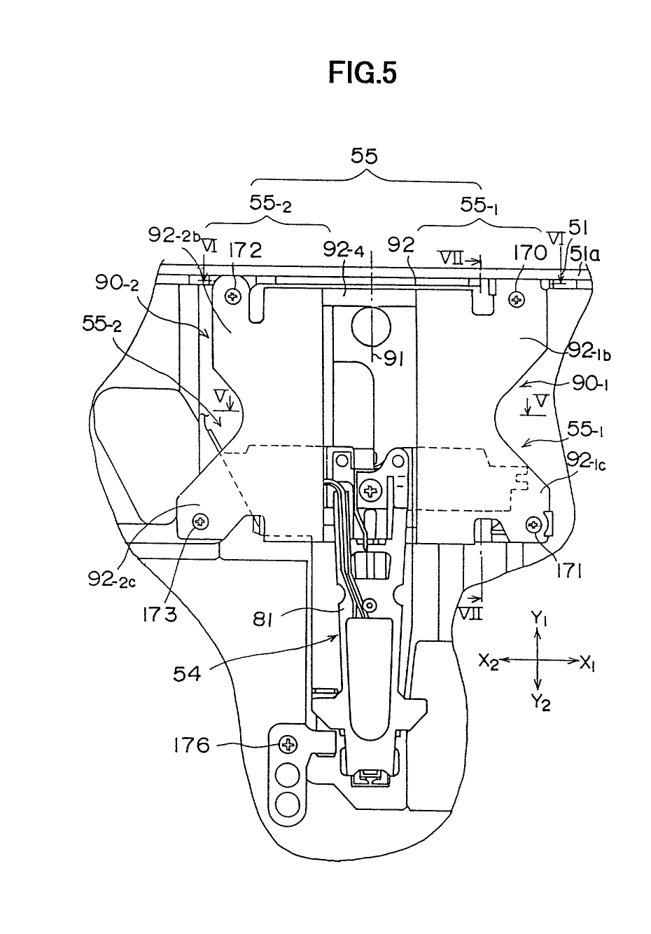

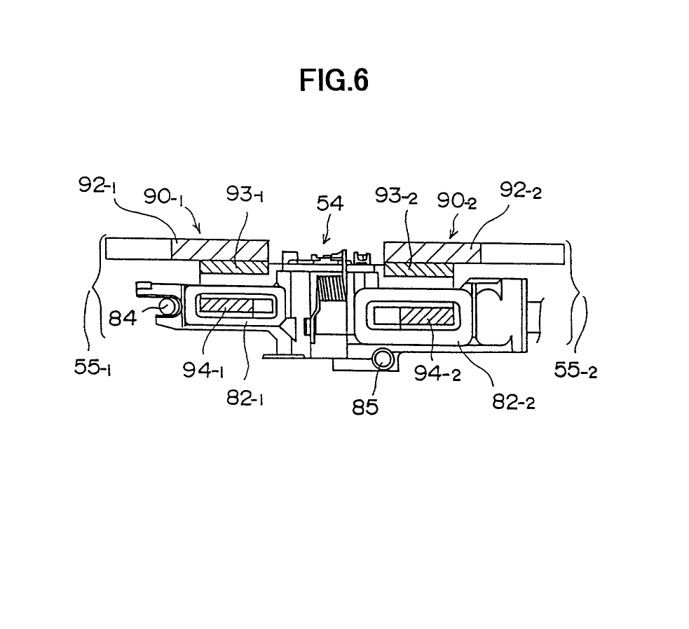

As represented in FIGS. 4-8, the head carriage 54 includes a carriage main body 80 carrying the lower magnetic head 71 at a tip end thereof and an upper head arm 81 carrying the upper magnetic head 70 at a tip end thereof, wherein the carriage main body 80 further carries thereon a pair of hollow drive coils 82₋₁ and 82₋₂ at respective lateral sides (X₁-side and X₂-side) of the carriage main body 80.

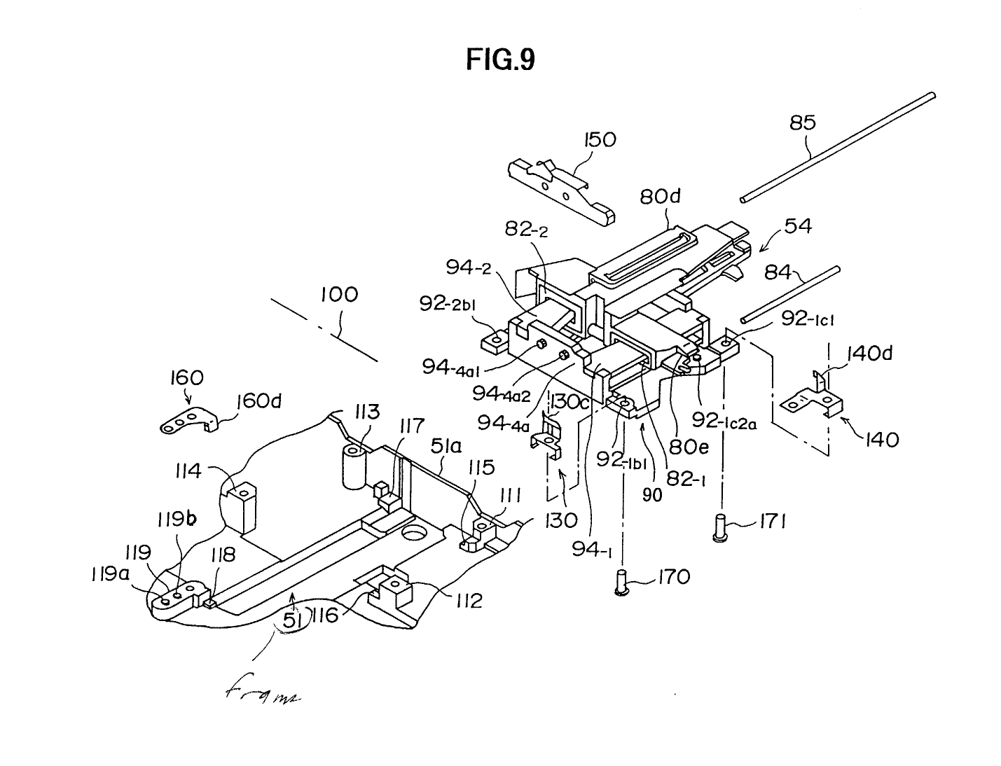

The head carriage 54 having the foregoing construction is held movably in the Y₁- and Y₂-directions by a pair of parallel guide rods 84 and 85 that are mounted on the frame 51 as will be described later. Further, it should be noted that the drive coils 82₋₁ and 82₋₂ are positioned properly by engaging with corresponding depressions 80a and 80b formed on the carriage main body 80. As can be seen in FIG. 9 described below, the guide rod 80 penetrates through a bearing part 80c of the carriage 80. On the other hand, the guide rod 84 engages with a U-shaped part 80d of the carriage main body 80.

FIG. 9 shows the head carriage 54 and the voice coil motor 55 in the state overturned with respect to a hypothetical axial line 100, wherein it should be noted that FIG. 9 shows the head carriage 54 and the voice coil motor 55 together with the frame 51.

Referring to the foregoing drawings including FIG. 9, it can be seen that the voice coil motor 55 is formed of a voice coil motor element 55₋₁ disposed at the X₁-side of the head carriage path, in which the head carriage 54 moves, and another voice coil motor element 55₋₂ at the X₂-side of the foregoing head carriage path, wherein the voice coil motor element 55 includes a magnetic circuit element 90₋₁ at the X₁-side and a driving coil 82₋₁ cooperating therewith. Further, the voice coil motor element 55₋₂ includes a magnetic circuit element 90₋₂ at the X₂-side and a driving coil 82₋₂ cooperating therewith. It should be noted that the magnetic circuit elements 90₋₁ and 90₋₂ are formed as an integral body and disposed generally symmetrically with respect to a central line 91 of the head carriage path. The magnetic circuit element 90₋₁ and 90₋₂ form together a magnetic circuit structure 90.

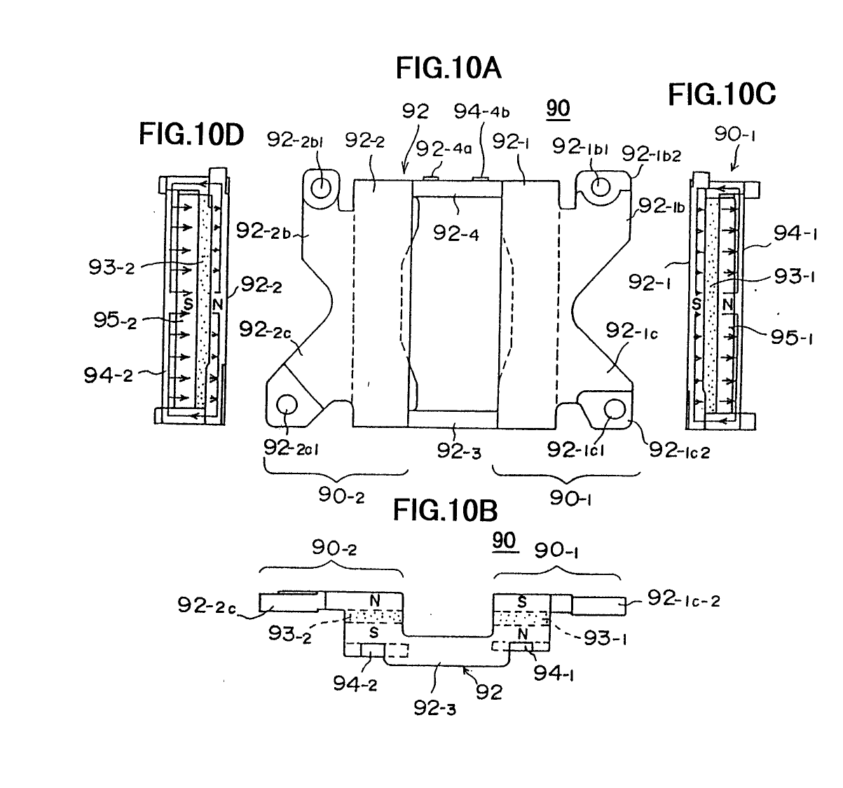

As represented in FIGS. 10A-10D, the magnetic circuit structure 90 is primarily formed by a permanent magnetic yoke 92, wherein the permanent magnetic yoke 92 includes a permanent magnet part 92₋₁ at the X₁-side, a permanent magnet part 92₋₂ at the X₂-side, a bridging frame 92₋₃ connecting the permanent magnet part 92₋₁ and the permanent magnet part 92₋₂ at the Y₂-side, and a bridging frame 92₋₄ connecting the permanent magnet part 92₋₁ and the permanent magnet part 92₋₂ at the Y₁-side. Thereby, the permanent magnetic yoke 92 has a generally rectangular form when viewed in a plan view.

It should be noted that the magnetic circuit element 90₋₁ at the X₁-side is formed of the foregoing permanent magnetic yoke part 92₋₁, a permanent magnet 93₋₁ mounted on the underside of the yoke part 92₋₁, and a yoke 94₋₁ provided further on the permanent magnet 93₋₁ in magnetic coupling with the permanent magnetic yoke part 92₋₁, wherein there is formed a magnetic gap 95₋₁ between the permanent magnet 93₋₁ and the yoke 94₋₁. The yoke 94₋₁ cooperates with the drive coil 82₋₁ at the X₁-side of the head carriage path.

The permanent magnet 93₋₁ has a form of an elongated plate and is magnetized to have an S-pole at the top side thereof and an N-pole at the bottom side. The yoke 94₋₁ penetrates through the drive coil 82₋₁ and is magnetically coupled to the magnetic yoke part 92₋₁ by connecting a first end thereof to a frame part 92₋₃ at the Y₂-side and a second, opposite end thereof to a frame part 92₋₄ at the Y₁-side. Thereby, the magnetic gap 95₋₁ is formed between the permanent magnet 93₋₁ and the yoke 94₋₁. As mentioned already, the drive coil 82₋₁ surrounds the foregoing yoke 94₋₁.

The magnetic circuit element 90₋₂ at the X₂-side is formed of the foregoing permanent magnetic yoke part 92₋₂, a permanent magnet 93₋₂ mounted on the underside of the yoke part 92₋₂, and a yoke 94₋₂ provided further on the permanent magnet 93₋₂ in magnetic coupling with the permanent magnetic yoke part 92₋₂, wherein there is formed a magnetic gap 95₋₂ between the permanent magnet 93₋₂ and the yoke 94₋₂. The yoke 94₋₂ cooperates with the drive coil 82₋₂ at the X₂-side of the head carriage path.

The permanent magnet 93₋₂ has a form of an elongated plate and is magnetized to have an S-pole at the top side thereof and an N-pole at the bottom side. The yoke 94₋₂ penetrates through the drive coil 82₋₂ and is magnetically coupled to the magnetic yoke part 92₋₂ by connecting a first end thereof to a frame part 92₋₃ at the Y₂-side and a second, opposite end thereof to a frame part 92₋₄ at the Y₁-side. Thereby, the magnetic gap 95₋₂ is formed between the permanent magnet 93₋₂ and the yoke 94₋₂. As mentioned already, the drive coil 82₋₂ surrounds the foregoing yoke 94₋₂.

By energizing the drive coils 82₋₁ and 82₋₂ by a drive current, the voice coil motors 55₋₁ and 55₋₂ are activated and the head carriage 54 is moved in the Y₁- and Y₂-directions with high precision.

Next, the structure related to the guide rods 84 and 85 will be described.

In the present embodiment, it should be noted that the guide rods 84 and 85 are mounted on the frame 51 by screwing the magnetic circuit structure 90 on the frame 51.

As represented in FIG. 10A, the permanent magnetic yoke part 92₋₁ includes lateral projections 92_{-1b} and 92_{-1c} projecting in the X₁-direction respectively at the Y₂-side and at the Y₁-side, while the permanent magnetic yoke part 92₋₂ includes lateral projections 92_{-2b} and 92_{-2c} projecting in the X₂-direction respectively at the Y₂-side and at the Y₁-side. Each projections such as the projection 92_{-1b} is formed with a screw hole such as the screw hole 92_{1b1}, 92_{1c1}, 92_{-2b1} or 92_{-2c1}, at the tip end thereof.

Further, it should be noted that the lateral projections 92_{-1b} and 92_{-1c} carry, at respective tip ends thereof, mounting pedestals 92_{-1b2} and 92_{-1c2} for mounting a guide-rod urging member. As represented in the bottom view of FIG. 9, the mounting pedestals 92_{-1b2} and 92_{-1c2} form a projection projecting at the rear side of the head carriage 54. In FIG. 10A, it can be seen that the frame 92₋₄ at the Y₁-side is also formed with mounting pedestals 92₋₄ₐ for mounting a guide-rod urging member, wherein the pedestals 92₋₄ₐ form projections 92₋₄ₐ₁ and 92₋₄ₐ₂ projecting in the Y₁-direction.

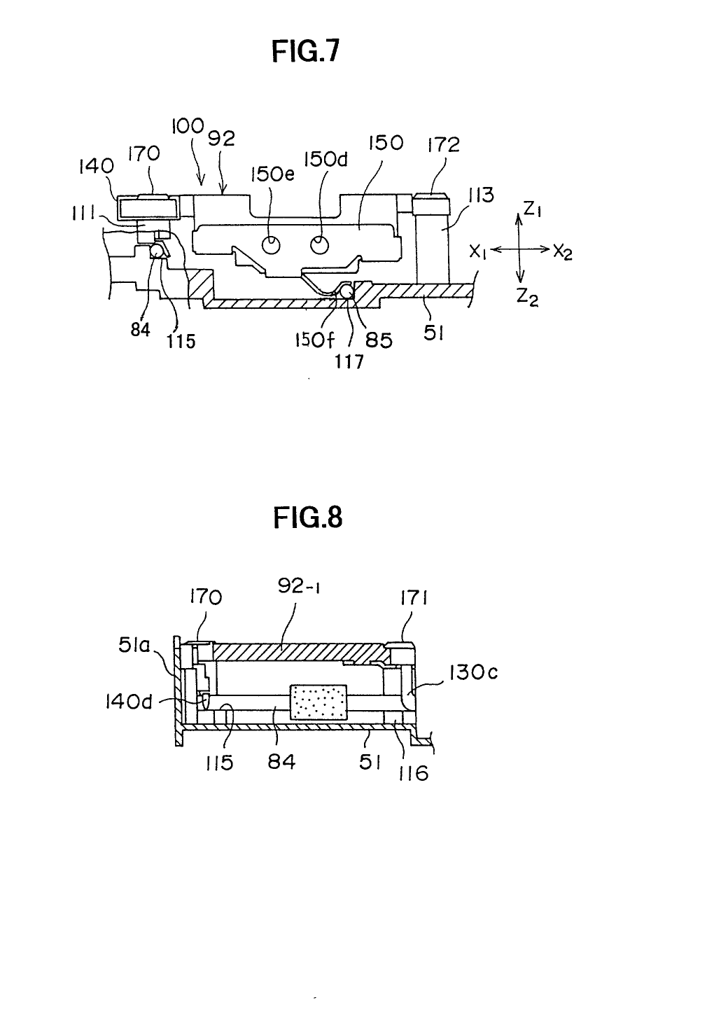

As represented in FIG. 9, the frame 51 includes mounting pedestal parts 111, 112, 113 and 114 for mounting the magnetic circuit structure 90, more specifically the permanent magnetic yoke 92 of the magnetic circuit structure 90. Further, the frame 51 is formed with right-angular pedestals 115 and 116 with high precision for accepting the respective ends of the guide rod 84. See also FIG. 7. Similarly, the frame 51 is formed with right-angular pedestals 117 and 118 with high precision for accepting the respective ends of the guide rod 85. See FIG. 7. In addition, there is formed a mounting pedestal 119 adjacent to the pedestal 118 for mounting the guide-rod urging member.

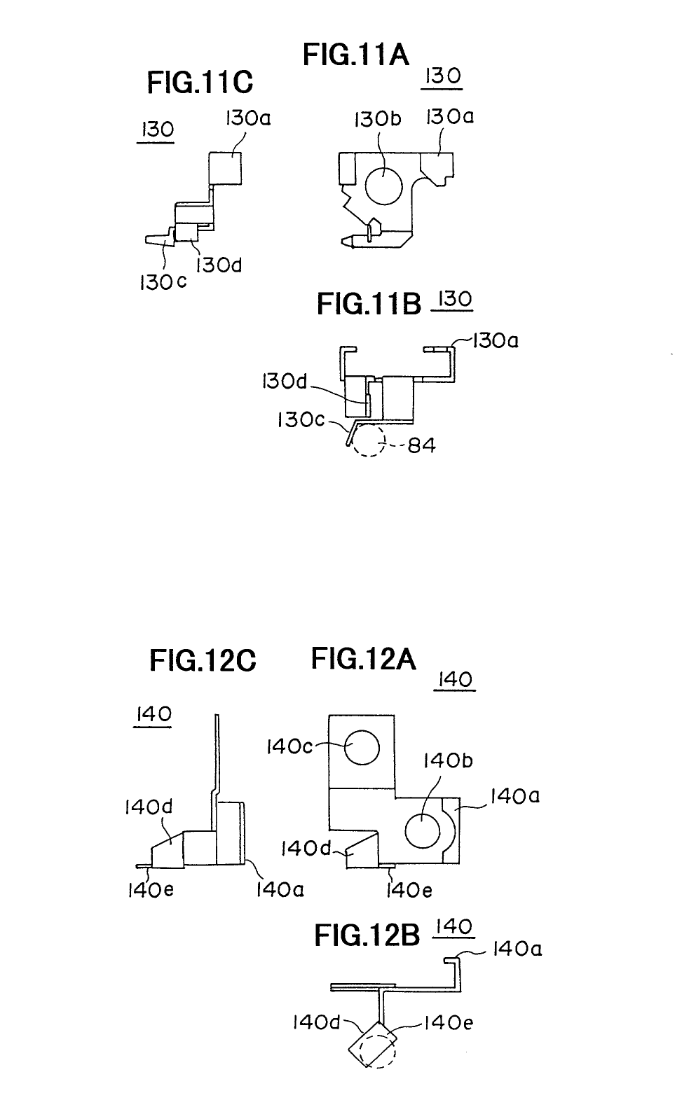

FIGS. 11A-11C show the construction of a guide-rod urging member 130, wherein the guide-rod urging member 130 is mounted on the mounting pedestal 92_{-1b2} of the permanent magnetic yoke 92 and urges the guide rod 84 at the Y₁-end thereof.

Referring to FIGS. 11A-11C, the guide-rod urging member 130 is formed by a press-forming process of a metal piece and includes a hook-shaped mounting part 130a, a screw hole 130b, a leaf spring part 130c urging the guide rod 84, and a stopper part 130d preventing an excessive bending of the leaf spring 130c. The leaf spring 130c has a V-shaped form engulfing a part of the outer surface of the guide rod 84.

FIGS. 12A-12C show the construction of a guide-rod urging member 140, wherein the guide-rod urging member 140 is mounted on the pedestal 92_{-1c2} of the permanent magnetic yoke 92 and urges the guide rod 84 at the Y₂-end thereof.

Referring to FIGS. 12A-12C, the guide-rod urging member 140 is formed by a press-forming process of a metal piece and includes a hook-shaped mounting part 140a, a screw hole 140b, a hole 140c fitting the pedestal 92_{-1c2}, a leaf spring part 140d urging the guide rod 84, and a stopper part 140e catching the end of the guide rod 84.

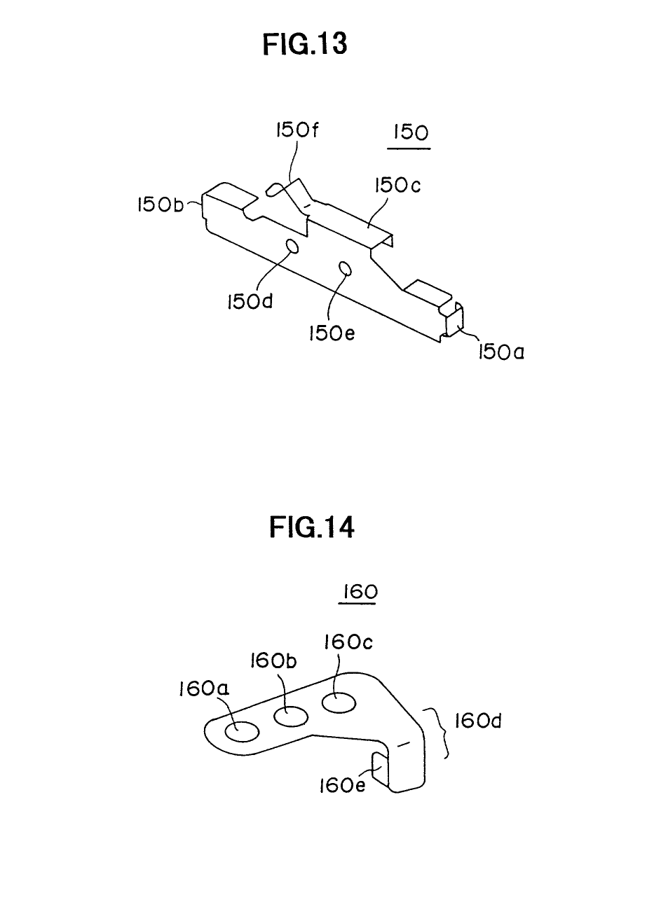

FIG. 13 shows the construction of a guide-rod urging member 150, wherein the guide-rod urging member 150 is mounted on the mounting pedestal 92₋₄ₐ of the permanent magnetic yoke 92 and urges the guide rod 85 at the Y₁-end thereof.

Referring to FIG. 13, the guide-rod urging member 150 is formed by a press-forming process of a metal piece and includes hook-shaped mounting parts 150a-150c, holes 150d and 150e fitting the pedestals 92₋₄ₐ₁ and 92₋₄ₐ₂, and a leaf spring part 150f extending from the mounting part 150c. The leaf spring part 150f thereby urges the guide rod 85. The leaf spring 150f has a V-shaped form engulfing a part of the outer surface of the guide rod 85.

FIG. 14 shows the construction of a guide-rod urging member 160, wherein the guide-rod urging member 160 is mounted on the mounting pedestal 119 and urges the guide rod 85 at the Y₂-end thereof.

Referring to FIG. 14, the guide-rod urging member 160 is formed by a press-forming process of a metal piece and includes a screw hole 160c and holes 160a and 160b fitting the projections 119a and 119b of the mounting pedestal 119, a leaf spring part 160d urging the guide rod 85. Further, there is provided a stopper part 160e catching the end of the guide rod 85.

Each of the foregoing members 130, 140, 150 and 160 has a weak magnetism and is attached to the permanent magnetic yoke 92 by a magnetic force.

Hereinafter, the process of mounting the guide rods 84 and 85 will be described for facilitating the understanding of the assembled structure.

(1) First, the guide-rod urging member 150 is mounted on the Y₁-side frame part 92₋₄ of the permanent magnetic yoke 92 by fitting the mounting parts 150a-150c with the mounting pedestals 92₋₄ₐ and by fitting the holes 150d and 150e with the projections 92₋₄ₐ₁ and 92₋₄ₐ₂.

(2) Next, the guide rod 85 is inserted into the bearing part 80c of the head carriage 54 such that the guide rod 85 makes an engagement with the U-shaped part 80d. See FIG. 9.

(3) Next, the guide-rod urging member 130 is mounted provisionally on the mounting pedestal 92_{-1b2} by a magnetic attraction force in the state that the mounting part 130a of the hook shape is engaged with the mounting pedestal 92_{-1b2}. In this state, the hole 130b coincides with the hole 92_{-1b1}.

(4) Next, the guide-rod urging member 140 is mounted provisionally on the mounting pedestal 92_{-1c2} by a magnetic attraction force in the state that the mounting part 140a of the hook shape is engaged with the mounting pedestal 92_{-1c2}. In this state, the hole 140b coincides with the hole 92_{-1c}.

In this state, it should be noted that the leaf spring 130c is engaged with the Y₁-end of the guide rode 84 and that the leaf spring 140d is engaged with the Y₂-end of the guide rod 84. Further, the leaf spring 150f is engaged with the Y₁-end of the guide rod 85.

(5) The magnetic circuit structure 90 thus carrying the guide-rod urging members 130, 140 and 150 as noted before is then screwed on the frame 51. This screwing process is conducted first by an alignment process, in which the respective ends of the guide rod 84 are positioned on the right-angular pedestals 115 and 116 and the respective ends of the guide rod 85 are positioned on the right-angular pedestals 117 and 118. As a result of the alignment process, the lateral projections 92_{-1b}, 92_{-1c}, 92_{-2b} and 92_{-2c} are respectively located on the mounting pedestals 111, 112, 113 and 114 on the frame 51. In this state, screws 170-173 are inserted into the holes 92_{-1b1}, 92_{-1c1}, 92_{-2b1} and 92_{-2c1} and tightened against the mounting pedestals 111, 112, 113 and 114.

The guide-rod urging members 130 and 140 are thereby mounted by the screws 170 and 171 together with the magnetic circuit structure 90 (permanent magnet yoke 92).

When the magnetic circuit structure 90, more specifically the permanent magnet yoke 92 is screwed, the leaf springs 130c, 140d and 50f are deflected, and the resultant urging force of the springs urges the both end of the guide rod 84 and the Y₁-end of the guide rod 85 against the foregoing right-angular pedestals 115 and 116.

As the guide-rod urging members 130 and 140 are provisionally mounted on the magnetic circuit structure 90, the process of screwing of the magnetic circuit structure 90, more specifically the permanent magnet yoke 92, on the frame 51 is achieved efficiently.

(6) Next, the guide-rod urging member 160 is placed on the mounting pedestal 119 in the state that the holes 160a and 160b are engaged with the projections 119a and 119b, and the screw 176 is tightened in this state. Thereby, the guide-rod urging member 160 is mounted on the pedestal 119 with a proper alignment. Further, the leaf spring part 160d undergoes a deflection, and the resultant urging force of the spring urges the Y₂-end of the guide rod 85 against the right-angular pedestal 118.

From the foregoing, the magnetic circuit structure 90 is mounted on the frame 51 together with the head carriage 54, and the guide rods 84 and 85 are mounted on the frame 51.

From the description above, the guide rods 84 and 85 are fixed on the frame 51 by fixing the magnetic circuit structure 90 on the frame 51. Thereby, the screwing step for mounting the guide rods 84 and 85 on the frame 51 conducted separately from the screwing step of the screws 175 and 176 for mounting the guide-rod urging member 160, can be eliminated. As a result of the reduced number of the screwing steps, the process of assembling the head carriage 54 and the voice coil motor 55 is conducted efficiently.

When screwing the magnetic circuit structure 90 on the frame 51, one may also use a jig for holding the guide-rod urging members 130 and 140. Even in such a case, it is not necessary to rely on the use of such a jig, as the guide-rod urging member is already mounted on the magnetic circuit structure. Thus, the jig plays only a supplemental role and a jig of a simple construction may be used.

As indicated in FIGS. 7 and 8, the Y₁-end of the guide rod 84 is pressed obliquely in the downward direction by the leaf spring 140d and is urged against the rectangular pedestal 115. Similarly, the Y₂-end of the guide rod 84 is pressed obliquely in the downward direction by the leaf spring 130c and is urged against the rectangular pedestal 116. Further, the Y₁-end of the guide rod 85 is pressed obliquely in the downward direction by the leaf spring 150f and is urged against the rectangular pedestal 117, and the Y₂-end of the guide rod 85 is pressed obliquely in the downward direction by the leaf spring 160d and is urged against the rectangular pedestal 118.

Further, the guide rods 84 and 85 are prevented from displacement in the Y₁-direction by a rear wall 51a of the frame 51 and in the Y₂-direction by the stopper parts 140e and 160e. See FIG. 12B or FIG. 14.

It may also be possible to form the permanent magnet yoke 92 such that the permanent magnet yoke 92 directly urges the guide rods 84 and 85. However, in view of the required high precision for the height of the mounting pedestals 111-114, such an approach is deemed unrealistic. By intervening the guide-rod urging members 130, 140 and 150 between the permanent magnetic yoke 92 and the guide rods 84 and 85, it becomes possible to absorb any variation in the gap formed between the permanent magnet yoke member 92 and the guide rods 84 and 85 by the leaf spring 130c, 140d or 150f. Thereby, it is possible to form the mounting pedestals 111-114 with a normal precision. Further, the guide rods 84 and 85 are urged with reliability.

In the foregoing embodiment, it is noted that the magnetic circuit structure 90 is screwed on in the state that the guide-rod urging members 130, 140 and 150 are mounted provisionally on the magnetic circuit structure 90, more specifically the permanent magnet yoke 92. On the other hand, it is also possible to screw the guide-rod urging members 130, 140 and 150 simultaneously with the permanent magnetic circuit structure 90, and hence the permanent magnet yoke 92. In this case, the guide-rod urging members 130, 140 and 150 are separated from the magnetic circuit structure 90 in the state before the screwing step.

Further, it is also possible to form the guide-rod urging members 130 and 140 as a unitary body to the magnetic circuit structure 90.

[Second Embodiment]

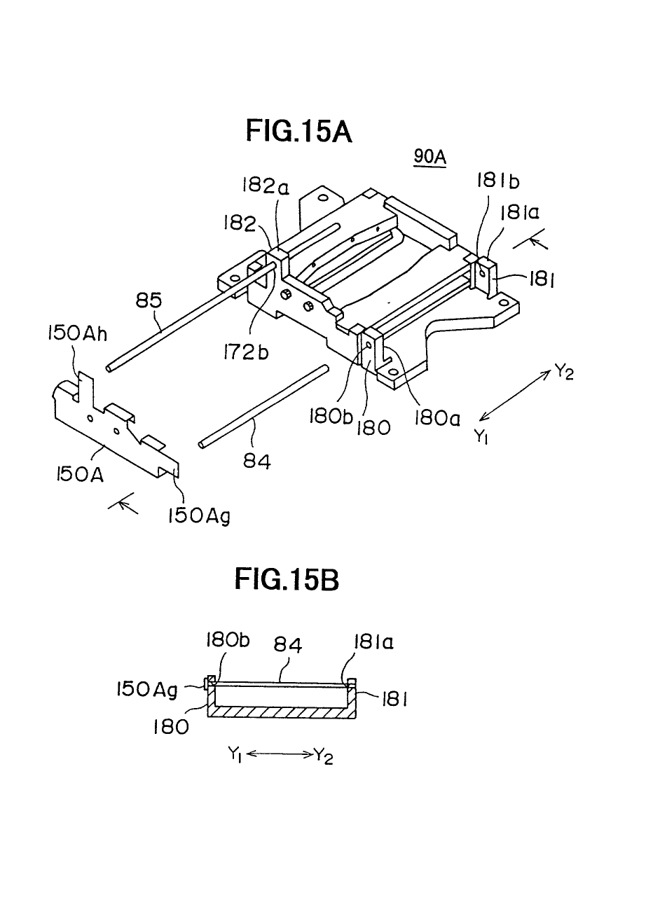

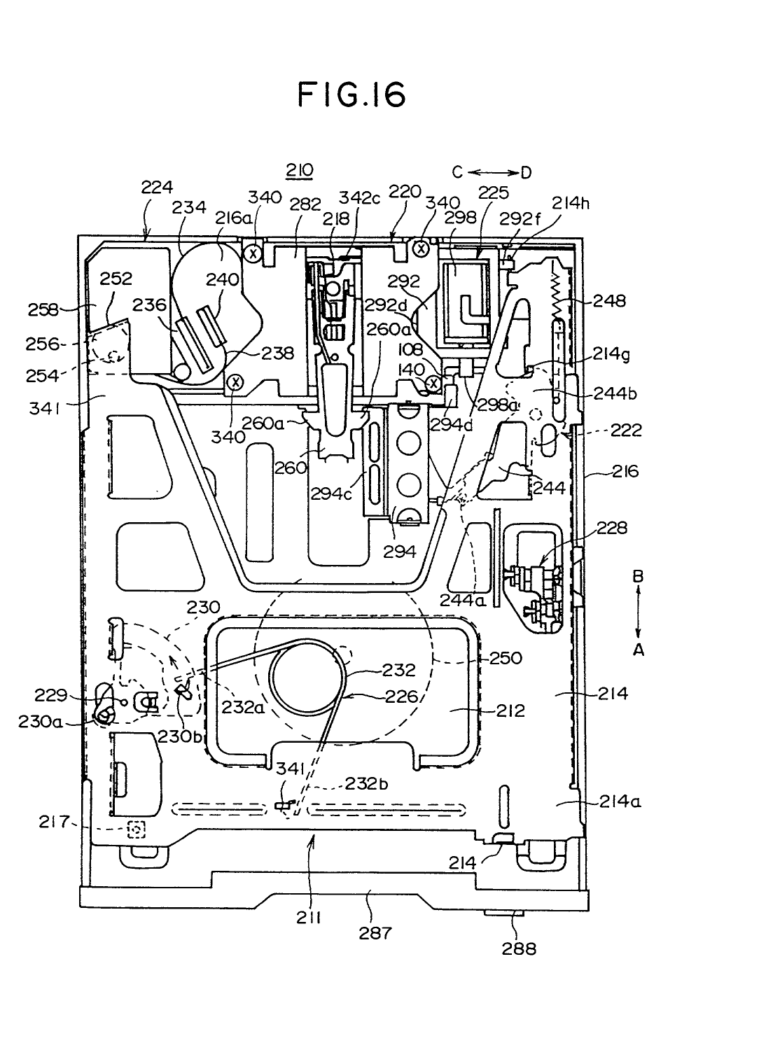

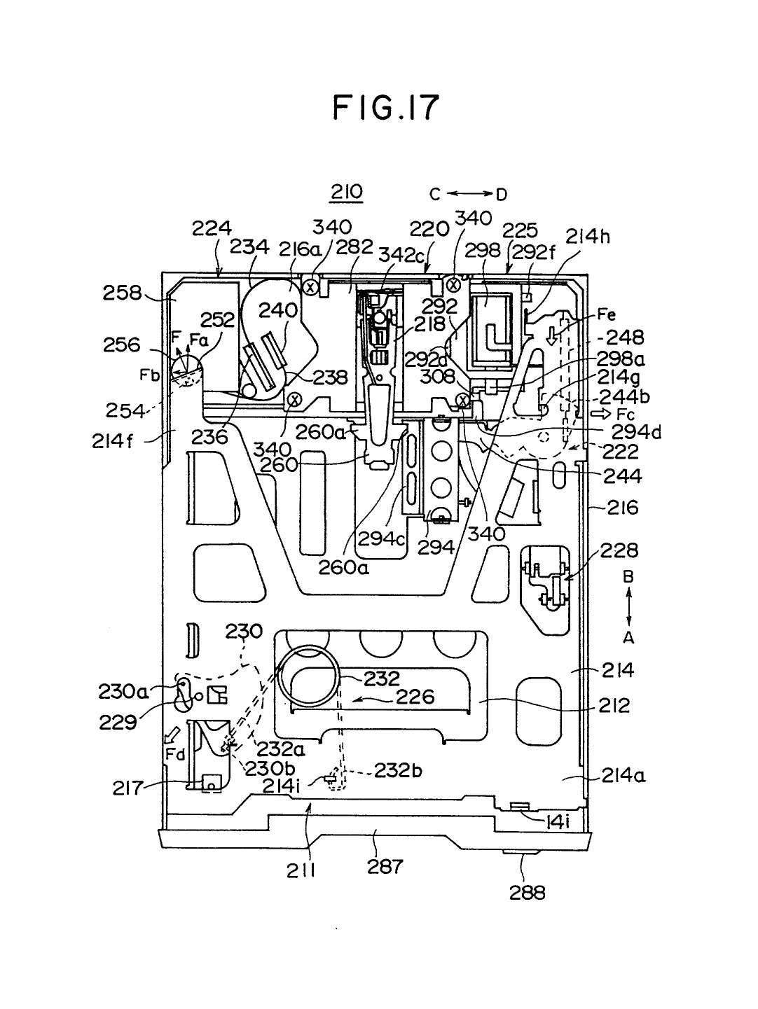

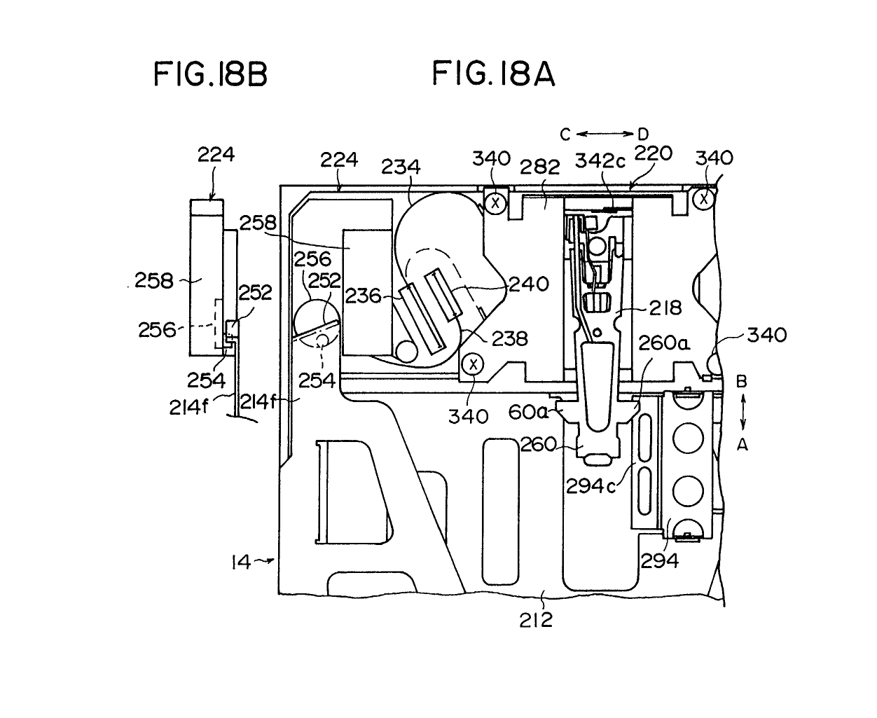

Next, a magnetic circuit structure 90A according to a second embodiment of the present invention will be described with reference to FIGS. 15A and 15B, wherein those parts of FIGS. 15A and 15B corresponding to the parts described previously are designated by the same reference numerals and the description thereof will be omitted.

Referring to FIGS. 15A and 15B, showing the bottom view of the magnetic circuit structure 90A, the magnetic circuit structure 90A includes a permanent magnetic yoke 92A in which guide-rod holders 180, 181 and 182 are added to the permanent magnetic yoke 92 of FIG. 9.

The guide-rod holder 180 and 181 are used to hold the guide rod 84, wherein the guide-rod holder 180 includes a pillar 180a formed with a penetrating hole 180b. Further, the guide-rod holder 181 includes a pillar 181a formed with a depression 181b. In the construction of FIG. 15A, the Y₁-end of the guide rod 84 is inserted into the penetrating hole 180b while the Y₂-end of the guide rod 84 is engaged with the depression 181b, and a tongue part 150Ag formed on a guide-rod urging member 150A mounted on the permanent magnetic yoke 92A prevents the dropping of the guide rod 84 by engaging the Y₁-end of the guide rod 84.

It should be noted that the guide-rod holding part 182 holds the Y₁-end of the guide rod 85 and includes a pillar 182a formed with a penetrating hole 182b. Thereby, dropping of the guide rod 85 from the guide-rod holding part 182 is prevented by a tongue part 150Ah formed on a part of a guide rod urging member 150A.

The magnetic circuit structure 90A thus holding the guide rods 84 and 85 are screwed on the frame similarly to the previous embodiment. Thereby, the Y₂-end of the guide rod 85 is fixed on the frame by a guide-rod urging member 160 of FIG. 13.

In the present embodiment, the screwing process just for screwing the guide rod is conducted only once, and the number of steps for assembling the head carriage and the voice coil motor is reduced.

The comparison of the first embodiment and the second embodiment is as follows.

In each of the first and second embodiments, the motor 52 for driving the turntable is mounted directly on the frame 51. In the first embodiment, the guide rods 84 and 85 are fixed directly on the frame. Thus, there is no intervening member between the guide rod 84 or 85 and the frame 51. In the second embodiment, on the other hand, the guide rods 84 and 85 are mounted on the permanent magnet yoke 92A, and thus, the permanent magnet yoke 92A intervenes between the guide rod 84 or 85 and the frame. Thus, the first embodiment provides a better precision for the guide rod 84 or 85 with respect to the permanent magnet yoke 92A as compared with the second embodiment. Thus, the first embodiment provides a better precision for the head carriage 54 with respect to the second embodiment.

[Third Embodiment]

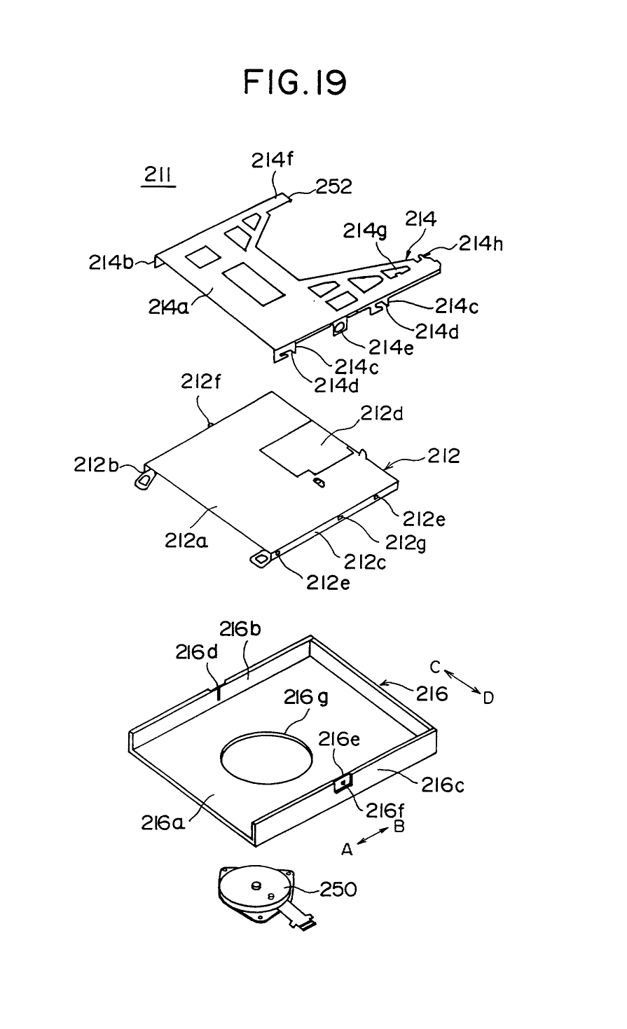

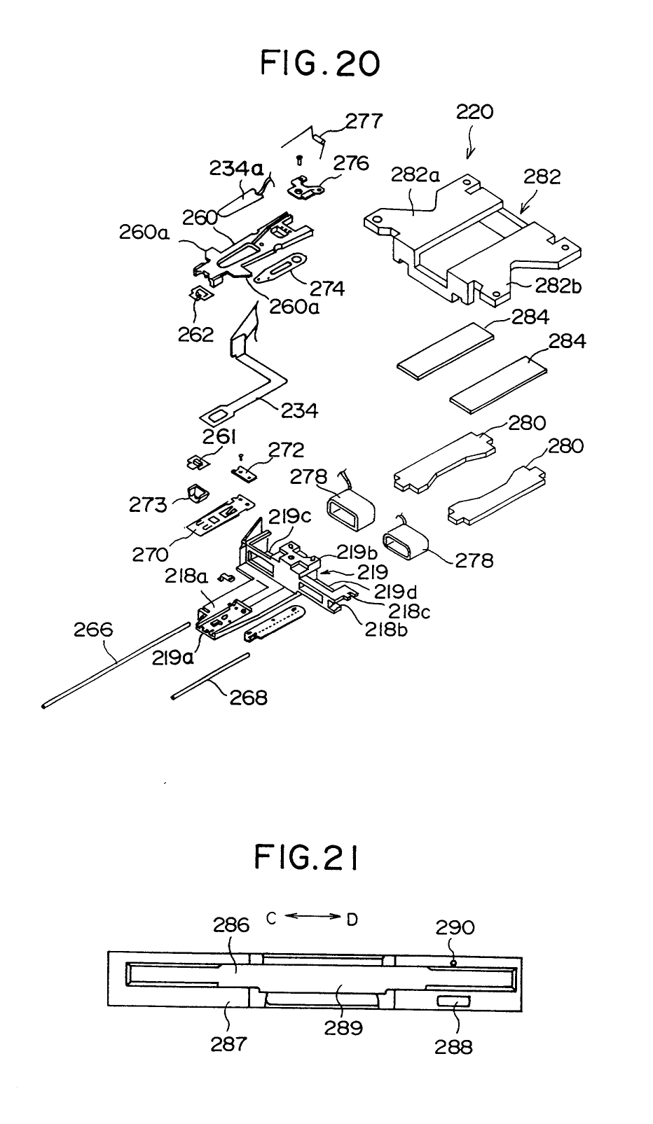

FIG. 16 shows the construction of a disk drive 210 according to a third embodiment of the present invention in the state before insertion of a disk cartridge, while FIG. 17 shows the disk drive of the third embodiment in the state that the disk cartridge is inserted.

Referring to FIGS. 16 and 17, the disk drive 210 includes a disk loading mechanism 211, wherein the disk loading mechanism 211 includes in turn a disk holder 212 accepting a disk cartridge not illustrated and a slider 214 movable in the A- and B-directions. Thereby, the slider 214 causes the disk holder 212 to move up and down in response to a slide movement thereof in the A- and B-directions. The disk holder 212 and the slider 214 are mounted on a frame 216. As noted above, the slider 214 moves on the frame 216 in the A- and B-directions, wherein the disk holder 212 is moved from an unloading position to a loading position in response to the insertion of the disk cartridge, which induces a movement of the slider 214 in the A-direction.

On the frame 216, there is provided a turntable 250 driven by a disk drive motor such that the turntable 250 projects in the upward direction from a surface 216a of the frame 216. Further, there is provided a head carriage 218 on the foregoing surface 216a of the frame 216. In the left-front side of the surface 216a of the frame 216, there is further provided a disk loading switch 217, wherein the disk loading switch 217 is formed of a micro-switch and detects the loading of the disk cartridge inserted into the disk holder 212. The disk loading switch 217 is represented by a broken line in FIGS. 16 and 17 in view of the fact that the disk loading switch 217 is provided at an underside of the disk holder 212.

On the surface 216a of the frame 216, there is provided a head carriage drive unit 220 driving the head carriage 218, a latch mechanism 222 latching the slider 214, an automatic ejecting mechanism 224 driving the slider 214 in the eject direction or B-direction, and a lock mechanism 225 that locks the head carriage 218 when there is no reading or writing of information made by the magnetic head. Further, a circuit substrate (not shown) is provided at the underside of the frame 216, wherein the circuit substrate carries a control circuit thereon.

In the present embodiment thus constructed, it should be noted that the lock mechanism 225 is provided at the right side of the head carriage 218, while the automatic ejecting mechanism 224 is provided at the left side of the head carriage 218.

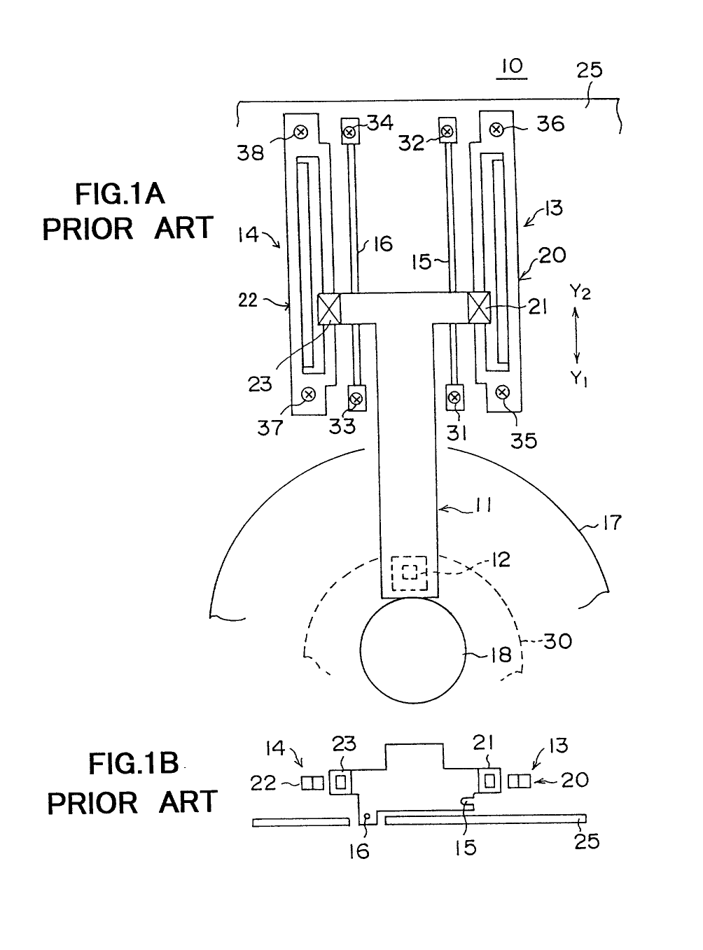

At the underside of the slider 214, there is provided a damper mechanism 226 for damping the slide movement of the slider 214 and a protection mechanism 228 protecting the disk drive 210 and the disk cartridge from erroneous insertion of the disk cartridge. It should be noted that the damper mechanism 226 includes a damper plate 230 shown in FIG. 1 by a broken line and a damper spring 232 cooperating therewith, wherein the damper plate 230 is supported rotatably on a shaft 229 of the slider 214 in the state that an end 230a of the damper plate 230 is engaged with the frame 216. On the other hand, the damper spring 232 urges the damper plate 230 at the other end thereof so as to cause a rotation in the damper plate 230. It should be noted that a first end 232a of the damper spring 232 is hooked on an engaging part 230b of the damper plate 230, while the other end 232b of the damper spring 232 is hooked on an engaging part 214i of the slider 214.

In the state that the slider 214 is located at the B-side with relative to a central position defined between an A-side position and a B-side position of the slider 214, the damper mechanism 226 urges the slider 214 in the B-direction by the urging force of the spring 232. When the slider 214 is located at the A-side with respect to the foregoing central position, on the other hand, the damper mechanism 226 urges the slider 214 in the A-direction as a result of the urging force of the spring 232.

Thus, the damper mechanism 226 urges the slider 214, when the slider 214 moves from the B-side position to the A-side position, first in the B-direction or opposite direction to the moving direction of the slider 214, and then in the A-direction or the moving direction of the slider 214. By doing so, it is possible to suppress the initial moving speed of the slider 214 and increase the final moving speed of the slider 214.

When the slider 214 is moved toward the cartridge insertion/ejection position, the damper spring 232 of the damper mechanism 226 urges the slider 214 in the B-direction. When the slider 214 is moved toward the cartridge loading position, on the other hand, the damper spring 232 urges the slider 214 in the A-direction.

It should be noted that the slider 214 is latched by the latch mechanism 222 and is moved in the A-direction by the insertion of the disk cartridge. In response to this, the disk holder 212 is moved from the disk unloading position to the disk loading position. The latch mechanism 222 is formed of a latch lever 244 and a coil spring 248 urging the latch lever 244 in the counter-clockwise direction.

The coil spring 248 has a first end hooked on the latch lever 244 and a second end hooked on the slider 214. Thereby, the coil spring urges the latch lever 244 in the counter-clockwise direction as noted above and simultaneously the slider 214 in the A-direction. By using the coil spring 248 commonly for urging the latch lever 244 and the slider 214, the number of parts forming the disk drive 210 is reduced.

It should be noted that the latch lever 244 includes an engaging part 244a engaging a shutter of the disk cartridge and another engaging part 244b engaging with a corresponding engaging part 214g of the slider 214.

When a disk cartridge is inserted into the disk holder 212 in the state of FIG. 16, the engaging part 244a undergoes a clockwise rotation as indicated in FIG. 17 and the shutter of the disk cartridge is opened. When the disk cartridge is fully inserted into the disk holder 212, the engaging part 214g of the slider 214 is disengaged from the engaging part 244b of the latch lever 244.

With this, the slider 214 undergoes a slide movement in the A-direction by the urging force of the coil spring 248 holding the slider 214 at the right end thereof, and the disk holder 212 is moved in the downward direction toward the disk loading position. When the disk holder 212 is thus lowered to the disk loading position, the magnetic disk held in the disk cartridge is clamped upon the turntable 250 such that the magnetic disk is rotatable together with the turntable 250.

It should be noted that the slider 214 includes a drive piece 214h formed at a left rear end thereof, wherein the drive piece 214h holds a lock member 292 to be described later to a lock position for locking the head carriage 218, when the disk cartridge is not mounted. As the lock member 292 is held at the lock position in cooperation with the movement of the slider 214, the head carriage 218 is positively locked as long as the disk cartridge is not loaded.

In the ejecting state of FIG. 17, it should be noted that a pressing of an ejection button 288 produces an ejection signal, wherein such a pressing of the ejection button 288 activates the automatic ejecting mechanism 224 upon the completion of the reading or writing of the loaded magnetic disk. In response to the activation of the automatic ejecting mechanism 224, the slider 214 is moved in the B-direction and the disk holder 212 is moved in the upward direction to the unloading position. Simultaneously, the latching of the latch lever 244 is canceled.

In response to the cancellation of the latch, the latch lever 244 is rotated in the counter-clockwise direction as a result of the urging force of the coil spring 248 and the disk cartridge in the disk holder 212 is ejected in the A-direction.

It should be noted that the automatic ejecting mechanism 224 prevents the immediate ejecting of the disk cartridge when the ejection button is pressed during the reading or writing operation of the magnetic disk. The ejection of the disk cartridge occurs only after the completion of reading or writing of the magnetic disk.

FIGS. 18A and 18B show the automatic ejecting mechanism 224 in an enlarged scale respectively in a plan view and a left side view.

Referring to FIGS. 18A and 18B, it should be noted that the automatic ejecting mechanism 224 includes a vertical edge part 252 formed at a left rear end 214f of the slider 214, a rotatable member 256 driving the slider 214 in contact with the edge part 252 at a contact pin 254 formed at a peripheral part of the rotatable member 256 for contact with the edge part of the slider 214. The rotatable member 256 is driven by an ejecting motor 258.

It should be noted that the edge part 252 extends obliquely with respect to the insertion and ejection directions or A- and B-directions and further obliquely with respect o the C- and D-directions. Thereby, a rotational movement of the rotatable member 256 urges the slider 214 in the ejecting direction or B-direction as a result of the engagement of the pin 254 and the slider 214. During this process, the edge part 252 experiences a force Fa acting in the B-direction and a force Fb acting in the C-direction.

As a result of this, the slider 214 experiences a force urging the same to rotate in the counter-clockwise direction, and the effect of the force acting on the slider 214 to rotate the same in the clockwise direction, caused by the force Fd of the damper spring 232 of the damper mechanism 226 and further by the force Fe of the coil spring 248, is effectively canceled out.

Thereby, the slider 214 is prevented from being urged to the side wall of the frame 216 and the slide resistance of the slider 214 is reduced substantially. In other words, the foregoing construction guarantees a smooth movement of the slider 214 in the ejecting direction.

Further, it should be noted that there are provided, between the head carriage 218 and the automatic ejecting mechanism 224, a connector 236 adapted to be connected to a flexible printed circuit board 234 of the head carriage 218 and another connector 240 for connection with a flexible printed circuit board 238 of the automatic ejecting mechanism 224.

It should be noted that the connectors 36 and 40 are disposed obliquely with respect to the moving direction of the head carriage 218 in a parallel relationship such that the connectors 36 and 38 face each other. The flexible printed circuit board 234 for the head carriage 218 is bent in a U-shaped form behind the connector 36 to which the printed circuit board 234 is connected, while the flexible printed circuit board 238 is bent in a U-shaped form at the front side of the connector 240 to which the printed circuit board 238 is connected.

By disposing the connectors 36 and 40 obliquely with respect to the C- and D-directions, the lateral bulge formed by the U-shaped bend of the flexible connector 36 or 40 is effectively accommodated in the space formed before or back of the connector 36 or 40.

FIG. 19 shows the disk loading mechanism 211 in an exploded view.

Referring to FIG. 19, the disk holder 212 includes a cover plate 212a and cartridge guides 212b and 212c extending from both lateral sides of the cover plate 212a so as to enclose the disk cartridge inserted into the disk holder 212. Thereby, the space defined by the cover plate 212a and the cartridge guides 212b and 212c is used for accommodating the disk cartridge.

At each lateral side of the disk holder 212, there are provided a pair of pins 212e. Further, guide parts 212f and 212g are formed respectively on the cartridge guides 212b and 212c as a projection. It should be noted that the guide parts 212f and 212g guide the up and down movements of the disk holder 212 by engaging with corresponding guide grooves 216d and 216e formed on the side walls 216b and 216c of the frame 216.

As will be described later, the disk holder 212 makes a contact with a projection 160a of the head arm 160 with the up and down movement thereof, wherein the disk holder 212 undergoes a rotation so as to cause a stepwise lowering of the head arm 260.

It should be noted that the slider 214 is mounted slidably at the upper part of the disk holder 212, wherein the slider 214 is formed of a generally J-shaped flat plate part 214a, a pair of side wall parts 214b and 214c extending from the flat plate part 214a so as to be bent in the downward direction from respective lateral edges of the flat plate part 214a, an obliquely inclined groove 214d formed on each of the side wall parts 214b and 214c so as to engage with the pin 212e of the disk holder 212, and an engaging hole 214e for engagement with a projection 216f projecting at each side wall of the frame 216 in correspondence to a generally central part of the frame 216 in the A- and B-directions.

Further, the frame 216 is formed with an opening 216g for accepting the turntable 250 generally at a central part of a flat surface part 216a.

FIG. 20 shows the construction of the head carriage mechanism in an exploded view.

Referring to FIG. 20, the head carriage 218 includes a carriage main body 219 carrying, on a top surface thereof, a lower magnetic head 261 in correspondence to the tip end part, and a head arm 260 carrying, on a bottom surface thereof, an upper magnetic head 262 in correspondence to the tip end part.

The head carriage 218 is movable under guidance of guide shafts 266 and 268 that extend in the front- and rear-directions or A- and B-directions. At both lateral sides of the head carriage 218, there are formed bearing parts 218a and 218b for slide engagement with the guide shafts 266 and 268.

It should be noted that the bearing part 218a is a circular hole holding therein the main guide shaft 266, wherein the bearing part 218a determines the lateral position and further the height of the head carriage 218. On the other hand, the bearing 218b is a U-shaped bearing accepting the guide shaft 268. Thereby, the bearing 218 does not restrict the lateral position or longitudinal position of the guide shaft 218. The bearing 218b restricts only the height of the head carriage 218.

The head carriage 218 is moved in the A- and B-directions under guidance by the guide shaft 266 and the guide shaft 268 by a driving force of the voice coil motor 264 constituting the carriage moving mechanism to be described later. As a result of this, the magnetic heads 261 and 262 conduct desired magnetic recording or playback by making a slide engagement with a desired track on the magnetic disk not shown.

It should be noted that the carriage main body 219 includes an arm 219a extending in the A- and B-directions, wherein the arm 219a carries, on a top surface thereof, a lower suspension 270 in a state that the lower suspension is sandwiched between the arm 219a and a mounting plate 272, wherein the lower suspension 270 is formed of a leaf spring and carries the lower magnetic head 261 thereon via a lower block 273. The lower magnetic head 261 is soldered upon the flexible printed circuit board 234.

The head arm 260 is mounted on a base part 219b of the carriage main body 219 via a leaf spring 274, wherein the leaf spring 274 is mounted on the foregoing base part 219b at an end part of the leaf spring 274 by using a mounting plate 276. Thus, the head arm 260 is supported by the leaf spring 274 in a manner rotatable in the upward and downward directions and is urged in the downward direction by a torsion spring 277. Further, a flexible printed circuit board 234a is soldered upon the upper magnetic head 262 mounted on the tip end part of the head arm 260. It should be noted that the printed circuit board 234a is connected to the flexible printed circuit board 234 at a rear end part of the carriage main body 219.

The base part 219b of the carriage main body 219 includes lateral depressions 219c and 219d at both lateral sides thereof for accepting coils 278. It should be noted that each coil 278 includes an inner space in which a center yoke 280 is accommodated. The center yoke 280 is held so as to extend in the moving direction of the head carriage 218 or in the A- and B-directions by connecting both ends thereof to lateral parts 282a and 282b of a side yoke 282, wherein the side yoke 282 carries a plate-like magnet 284 at the lower side thereof in correspondence to the lateral parts 282a and 282b.

Thus, the coil 278 of the carriage main body 219 is mounted such that the upper part thereof intervenes between the center yoke 280 and the magnet 284. Thereby, an electromagnetic repulsion against the magnetism of the magnet 284 provides the driving force acting in the A- and B-directions. It should be noted that the coil 278, the center yoke 280, the side yoke 282 and the magnet 284 form together the foregoing voice coil motor 264.

FIG. 21 shows the magnetic disk drive in a front view.

Referring to FIG. 21, the disk drive includes a front bezel 287 having a disk insertion opening 286 at the front end part of the frame 214. Further, the front bezel plate 287 carries, at a lower right part thereof, an ejection button 288. It should be noted that the ejection button 288 produces an ejection signal by pressing an ejection switch disposed inside the front bezel 287.

On the rear side of the front bezel 287, there is provided a movable flap 289 closing the disk insertion opening 286 from the rear direction. Further, a small hole 290 above the disk insertion opening 286 is used to conduct a compulsory ejection operation, in case the automatic ejecting mechanism 224 is jammed, in which a rod is inserted into the hole 290 so as to press a vertical edge part 214j at the front part of the slider 214 in the B-direction.

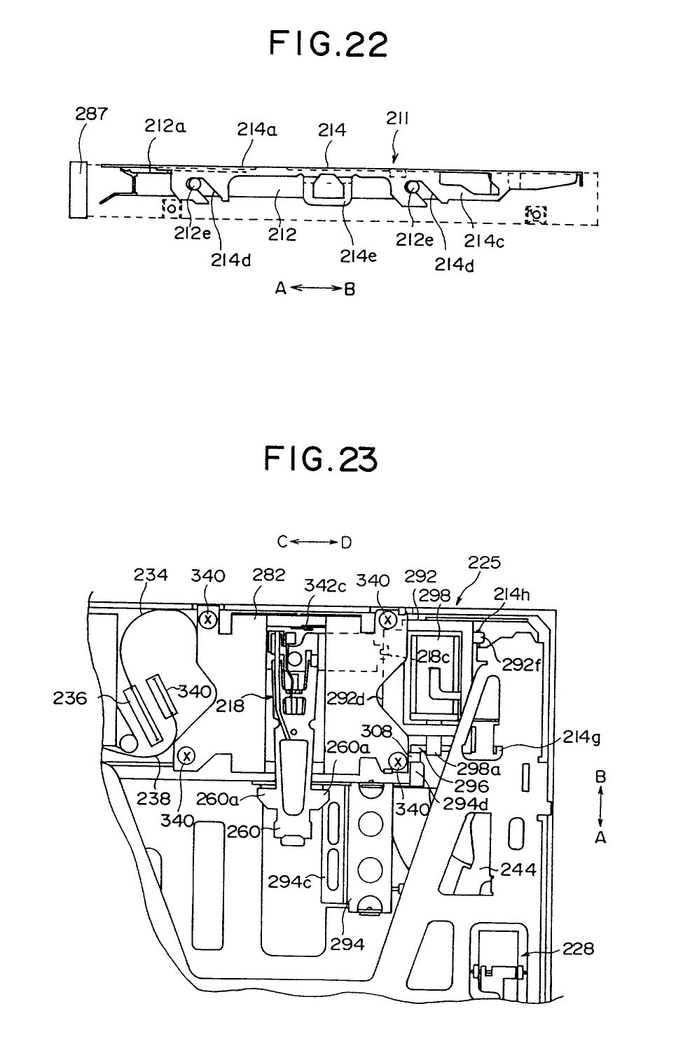

FIG. 22 shows the disk insertion/ejection mechanism formed by the disk holder 212 and the slider 214.

Referring to FIG. 22, the obliquely inclined groove 214d of the slider 214 is engaged with the pin 212e of the disk holder 212, and the slide movement of the slider 214 causes a movement of the pin 212e along the groove 214d. Thus, when the slider 214 is moved, in response to the insertion of the disk cartridge, to slide in the B-direction from the cartridge insertion position and reaches the cartridge insertion/ejection position, the disk holder 212 is caused to move in the upward direction to the disk unloading position.

When the slider 214 is caused to slide, in response to the ejection operation, in the A-direction from the cartridge insertion/ejection position, the disk holder 212 is lowered to the disk loading position. Thus, the disk holder 212 and the slider 214 constitute the disk loading mechanism 211.

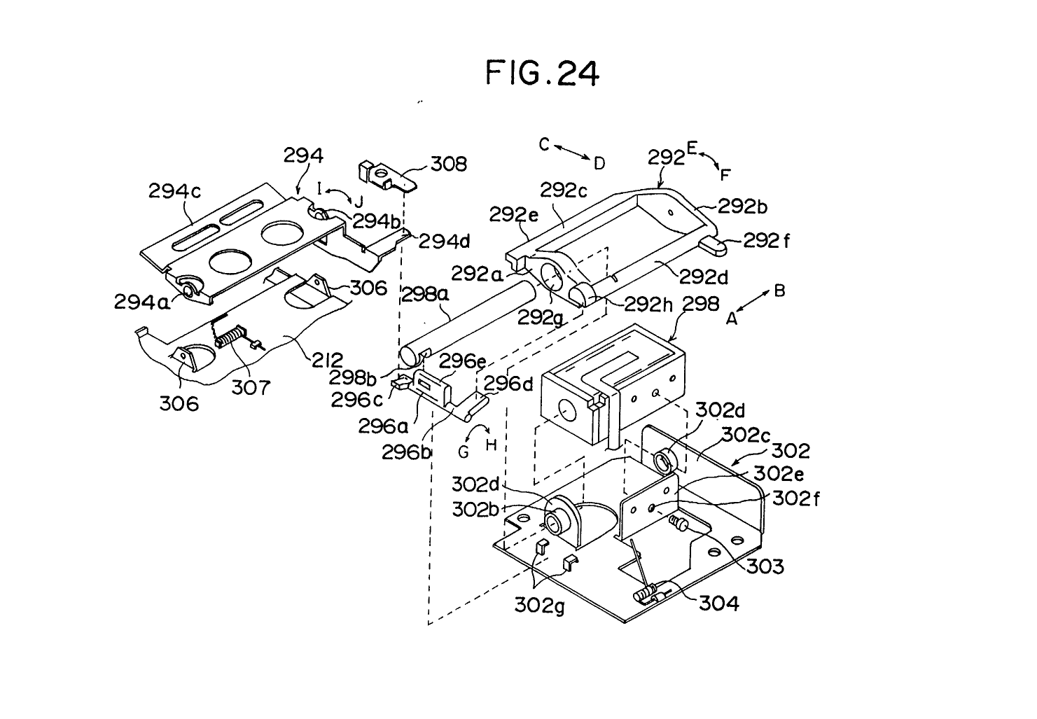

FIG. 23 is a plan view showing the head carriage lock mechanism 225 in an enlarged scale. Further, FIG. 24 shows the lock mechanism 225 in an exploded state.

Referring to FIGS. 23 and 24, the head carriage lock mechanism 225 generally includes a lock member 292, a lifter 294 and a solenoid 298. As will be described later, the head carriage lock mechanism 225 prevents the head carriage 218 to move until the disk cartridge is loaded. Thereby, the lock mechanism 225 releases the lock of the head carriage 218 after a predetermined time elapsed from the onset of activation of the disk motor and further causes the head arm 260 to move to the loading position.

The lock member 292 is a member having a form of a rectangular frame and includes front plate 292a and a rear plate 292b bridged by a left arm 292c and a right arm 292d extending in the A- and B-directions. Further, the lock member 292 includes an engaging lack 292e on the left arm 292c, which moves close to the head carriage 218, such that the engaging lack 292e engages with a corresponding engaging part 218c of the head carriage 218.

It should be noted that the lock member 292 is mounted in a manner such that the front plate 292a and the rear plate 292b are swingable about the axis of the solenoid 298, and the right arm 292d carries a contact part 292f adapted to contact with the drive piece 214h formed at the right hand side of the slider 214. Thus, the lock member 292 is mounted such that the center of rotation of the lock member 292 is coincident with the center of a shaft 298a of the solenoid 298.

At the central part of the front plate 292a of the lock member 292, there is provided a penetrating hole 292g for accepting the shaft 298a of the solenoid 298, wherein a bearing 302b formed on a support part 302a on a base 302 is engaged with the hole 292g. Further, there is provided a circular depression (cannot be seen in FIG. 23 or 24) in the rear plate 292b for engagement with a bearing part 302d, which is formed on a support part 302c on the base 302. Thereby, the lock member 292 is held rotatably by the support parts 302a and 302c formed on the base 302.

The lock member 292 is urged in the clockwise direction (F-direction) by a torsion spring 304 provided on the base 302 on which the solenoid 292 is mounted. Thus, the lock member 292 is rotated in the counter-clockwise direction (E-direction) in the state before the insertion of the disk cartridge, as a result of the drive piece 214h of the slider 214 pushing up the contact part 292f in the upward direction. In this state, the lack 292e is engaged with the engaging part 218c of the head carriage 218 and the head carriage 218 is locked from a movement.

Once the disk cartridge is mounted, the slider 214 is moved in the A-direction and the drive piece 214h is detached from the contact part 292f. Thereby, the lock member 292 is rotated in the clockwise direction (F-direction) by the urging force of the torsion spring 304. As a result of this, the lack 292e of the lock member 292 is disengaged from the engaging part 218c of the head carriage 218 and the head carriage 218 is unlocked. Thereby, the head carriage 218 becomes movable in the A- and B-directions.

It should be noted that the solenoid 298 is disposed between the support part 302a and the support part 302c in such a manner that the side part thereof is fixed by a screw 103 screwed into a threaded hole 302f formed in a side plate 302e. As the lock member 292 forms a rectangular frame surrounding the solenoid 298, the solenoid 298 does not occupy a space that can be otherwise used for other purposes. Thereby, the disk drive can be formed with a compact size.

At the front side of the support part 302a of the base 302, there are formed a pair of projections 302g for supporting a link member 296, wherein the link member 296 has a shaft 296a and a 296b held rotatably on the projections 302g. Further, the link member 296 includes a first contact part 296c contacting a lifter 294 at a first end thereof and a second contact part 296d contacting a right contact part 292h of the lock member 292. Further, the link member 296 includes an engaging part 296e at a central part thereof so as to make an engagement with a depression 298b formed at an end part of the shaft 298a of the solenoid 298.

In operation, the link member 296 is caused to slide in the B-direction, in response to the mounting of the disk cartridge, by a retraction movement of the shaft 298a of the solenoid 298, wherein the engaging part 296e engaging the shaft 298a undergoes a swinging motion by being driven in the slide direction (H-direction). With this, the second contact part 296d is rotated in the downward direction and the engagement of the second contact part 296d with the right contact part 292h of the lock member 292 is disengaged. Thereby, the lock member 292 is rotated in the lock release position (F-direction) by the urging force of the torsion spring 304.

The lifter 294 is supported rotatably by a pair of support parts 306 provided on the cover plate of the disk holder 212. Further, the lifter 294 is urged in the clockwise direction (J-direction) by the urging force of a torsion spring 307 provided on the cover plate of the disk holder 212.

Further, the lifter 294 includes, at both sides thereof, shaft holes 294a and 294b for engagement with the shafts (cannot be seen in the illustration of FIG. 24) projecting from the support part 306. In addition, the lifter 294 includes a contact part 294c extending in the A- and B-directions for engagement with a projecting part 260a of the head arm 260, and a drive piece 294d extending in the rear direction.

It should be noted that the drive piece 294d is disposed above the first contact part 296c of the link member 296 so as to face with the first contact part 296c. Thus, the link member 296 undergoes a rotation, in response to the electromagnetic retraction of the shaft 298a of the solenoid 298, which in turn is triggered by the mounting of the disk cartridge, in the slide direction (H-direction) of the shaft 298a. Thereby, the lifter 294 is rotated in the counter-clockwise direction (I-direction), and the head arm 260 is lowered such that the magnetic heads 261 and 262 are ready to carry out reading or writing of information from or to the magnetic disk.

When ejecting the disk cartridge, the lifter 294 is rotated in the clockwise direction (J-direction) by the urging force of the torsion spring 307. Thereby, the drive piece 294d urges the first contact part 296c of the link member 296 in the downward direction. With this, the second contact part 296d is rotated in the upward direction and the link member 296 urges the second contact part 292h of the lock member 292 in the upward direction. Thereby, the lock member 292 is rotated in the anti-clockwise direction (E-direction) to the lock position in which the head carriage 218 is locked.

Above the lifter 294, there is provided a pressing member 308 fixed upon the frame 216, wherein the pressing member 308 is contacted with the drive piece 294d at the time of the ejection mode as a result of the upward movement of the lifter 294.

It should be noted that the lifter 294 is urged in the clockwise direction (J-direction) by the urging force of the torsion spring 307 noted above, so as to raise the head arm 260. On the other hand, such a construction may cause a damage to the magnetic head 261 or 262 when an external shock is applied to the disk drive and a force exceeding the force of the torsion spring 307 is applied to the head arm 260.

In order to avoid this, the drive piece 294d is caused to make an engagement with the pressing member 308 in the eject mode of the disk drive. Thereby, the pressing member 308 prohibits the rotational movement of the drive piece 294d even when the lifter 294 is urged to rotate by the external shock, and the lowering of the head arm is effectively restricted. Thereby, the problem of collision of the magnetic head 261 or 262 is eliminated.

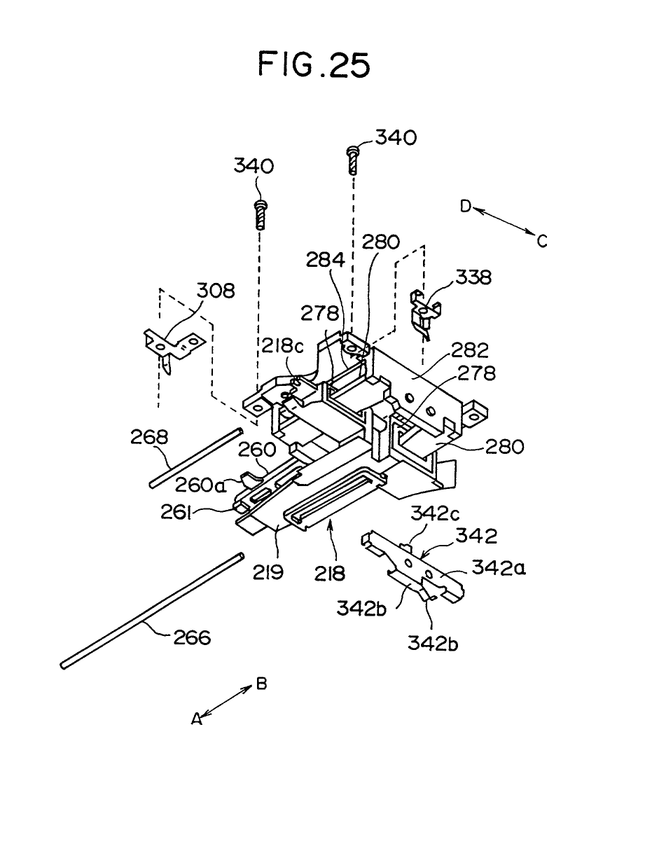

FIG. 25 shows the head carriage 218 in an exploded view.

Referring to FIG. 25, the carriage main body 219 of the head carriage 218 is guided, at both lateral sides thereof, by a pair of guide shafts 266 and 268 and is movable in the radial direction (A- and B-directions) of the magnetic disk. Further, the center yoke 280 held by the side yoke 282 of the voice coil motor 264 is inserted into the coil 278 mounted on the head carriage 218.

At the D-side of the carriage main body 219, the pressing member 308 and further a pressing member 338 are screwed upon the frame 216 by screws 340 together with the side yoke 282, wherein the pressing members 308 and 338 are formed of a leaf spring urging the guide shaft 268.

On the rear wall of the frame 216, there is provided a pressing member 342 for urging the end of the guide shaft 268, wherein the pressing member 342 is formed of a leaf spring.

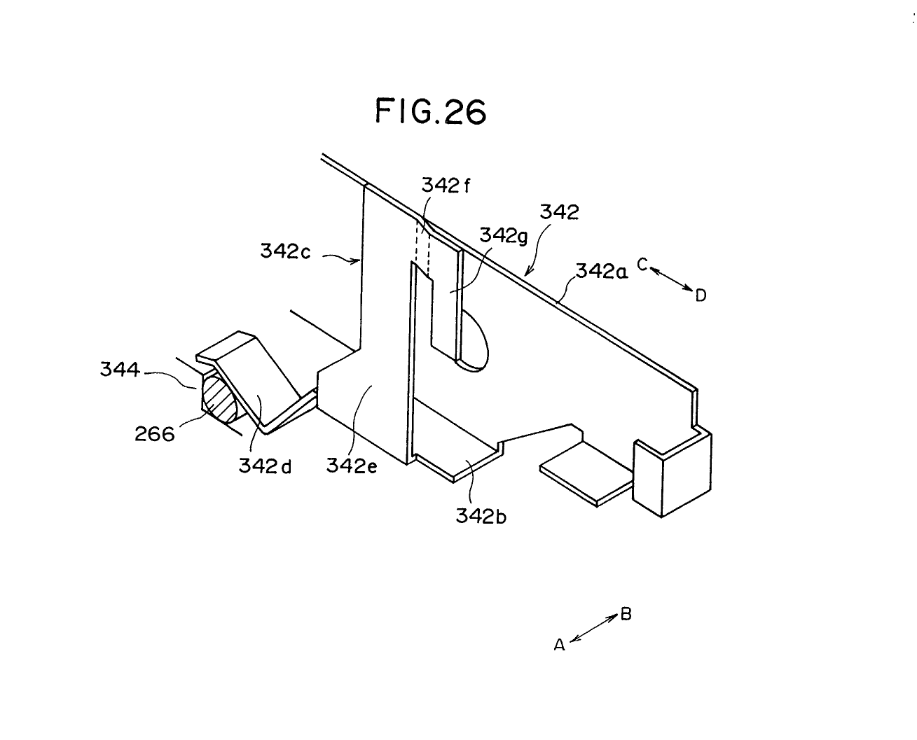

FIG. 26 shows the pressing member 342 in an enlarged scale.

Referring to FIG. 26, the pressing member 342 includes a mounting part 342a adapted to be mounted on the rear wall of the side yoke 282, a horizontal part 342b extending in the forward direction (A-direction) from the mounting part 342a, a shock absorbing part 342c standing up vertically from the horizontal part 342b, and a shaft-pressing part (holding member) 342d having an inclined part extending laterally therefrom, wherein the laterally extending part of the shaft-pressing part 342d urges the end of the guide shaft 268 against a corresponding holding part 344 formed on the frame 216.

It should be noted that the shock absorbing part 342c constitutes the essential part of the present embodiment and includes a vertical part 342e extending vertically from the side yoke supporting part 342b, an inclined part 342f inclined from the vertical part 342e in the forward direction (A-direction), and a supporting part 342g formed at the tip end of the inclined part 342f for facing the base part 219b of the carriage main body 219.

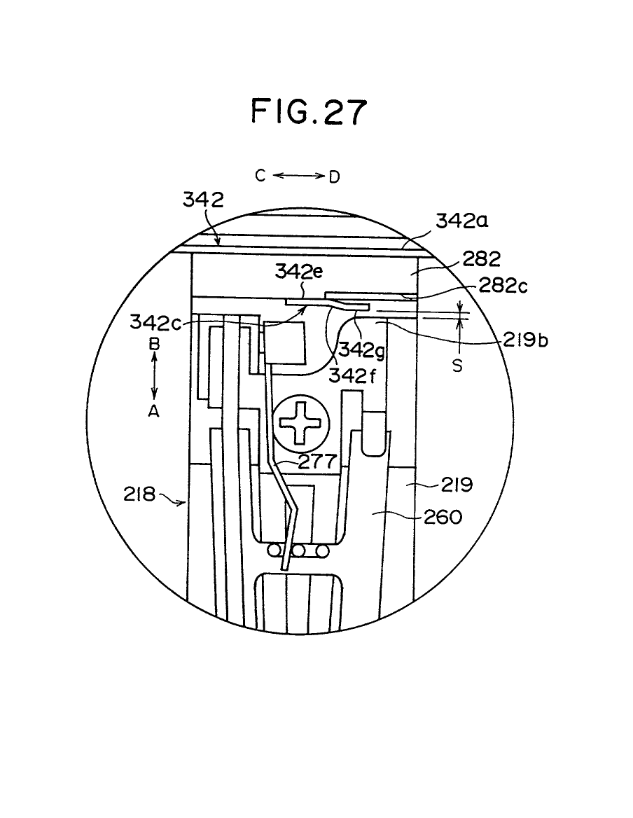

FIG. 27 shows the relationship between the rear base part 219b of the carriage main body 219 and the supporting part 342g in a plan view.

Referring to FIG. 27, the rear base part 219b of the carriage main body 219 faces the supporting part 342f of the pressing member 342 mounted on the frame 216 with a minute gap S therebetween in the state that the head carriage is fully moved in the B-direction.

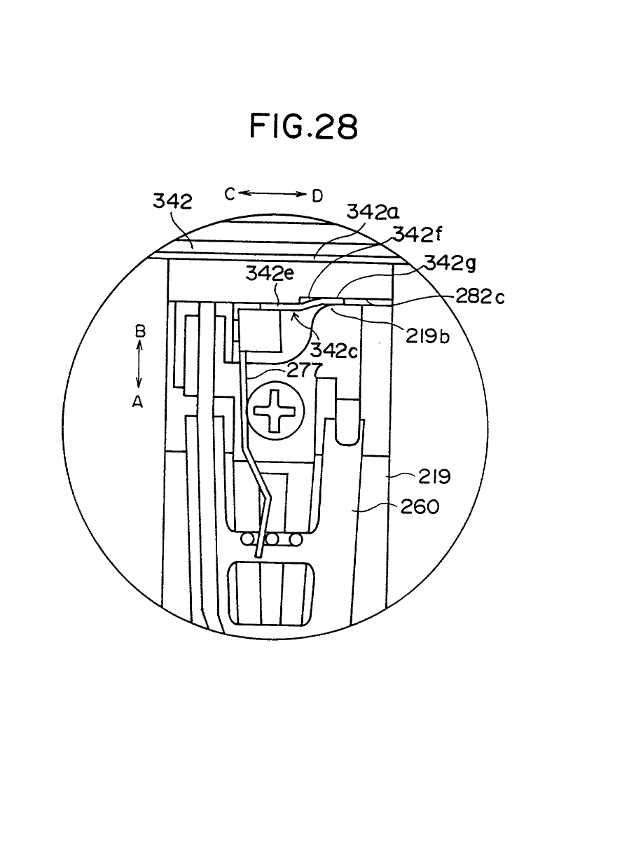

FIG. 28 shows the state in which the foregoing rear base part 319a of the carriage main body 319 is engaged with the foregoing supporting part 342g in a plan view.

FIG. 28 shows the case in which a large acceleration is transmitted to the head carriage 218 from outside the disk drive or the driving force of the voice coil motor 264 during the seek operation has become excessive and the head carriage 218 has moved beyond the nominal range of slide movement. In such a case, the rear base part 219b of the carriage main body 219 may make a contact with the supporting part 342g. When this occurs, the supporting part 342g undergoes a deformation as a result of the urging force acting in the B-direction and is accommodated in a depression 282c formed in the side yoke 282.

As a result of the foregoing deformation, the inclined part 342f, which is inclined in the A-direction before the collision, is now inclined in the B-direction after the collision, and the shock of the collision to the head carriage 218 is effectively reduced and the damage thereto is eliminated.

The magnitude of the shock may change variously depending on the mass of the head carriage 218 or the acceleration. By choosing the thickness of the shock absorbing part 342c and the angle of inclination of the inclined part 342f suitably, the present embodiment can eliminate the damage to the head carriage 218 effectively.

As the shock absorbing part 342c is formed of the inclined part 342f and the supporting part 342g as noted above, the magnitude of projection in the A- or B-direction is small, and the shock absorbing construction of the present embodiment can be formed to have a compact size.

As the foregoing shock absorbing part 342c is formed integrally with the side yoke supporting part 342b or the shaft pressing part 342d, the number of parts needed for constituting the foregoing shock absorbing construction is minimum, and the disk drive can be assembled efficiently.

It should be noted that the present embodiment is not limited to a floppy disk drive noted before, but is applicable also to various storage drives including optical disk drives, magneto-optical disk drives, and card-type disk drives such as a so-called memory card.

Although the foregoing embodiment has used the construction in which the slider moved above the disk holder, the present embodiment is applicable also to the case in which the slider slides below the disk holder.

Further, it is of course possible to use a spring such as a coil spring on the rear wall of the frame 216 in place of the shock absorbing part 342c.

Further, the present invention is by no means limited to the embodiments described heretofore, but various variations and modifications may be made without departing from the scope of the invention.

What is claimed is:

1. A disk drive, comprising:
a frame;
a rotatable turntable adapted to support a disk;
a head carriage movable in a radial direction of said disk in a state that said disk is held on said turntable;
a head provided on said head carriage, said head conducting writing or reading of information to and from said disk;
a guide rod fixed on said frame so as to guide said head carriage;
a voice coil motor including a magnetic circuit screwed on said frame and a drive coil mounted on said head carriage, said voice coil motor causing said head carriage to move in said radial direction of said disk;
a guide-rod catching member provided on said frame so as to catch said guide rod; and
a resilient guide-rod urging member screwed on said frame together with said magnetic circuit, such that said guide-rod urging member resiliently urging said guide rod against said guide-rod catching member.

2. A disk drive, comprising:
a frame;
a rotatable turntable adapted to support a disk;
a head carriage movable in a radial direction of said disk in a state that said disk is held on said turntable;
a head provided on said head carriage, said head conducting writing or reading of information to and from said disk;
a guide rod fixed on said frame so as to guide said head carriage;
a voice coil motor including a magnetic circuit screwed on said frame and a drive coil mounted on said head carriage, said voice coil motor causing said head carriage to move in said radial direction of said disk;
a guide-rod catching member provided on said frame so as to catch said guide rod; and
a resilient guide-rod urging member having a part adapted to be mounted on said magnetic circuit, said resilient guide-rod urging member being mounted on said magnetic circuit such that said guide-rod urging member resiliently urges said guide rod against said guide-rod catching member,
said magnetic circuit being screwed on said frame in a state that said guide-rod urging member is provided on said magnetic circuit.

3. A disk drive, comprising:
a frame;
a rotatable turntable adapted to support a disk;
a head carriage movable in a radial direction of said disk in a state that said disk is held on said turntable;
a head provided on said head carriage, said head conducting writing or reading of information to and from said disk;
a guide rod fixed on said frame so as to guide said head carriage; and
a voice coil motor including a magnetic circuit screwed on said frame and a drive coil mounted on said head carriage, said voice coil causing said head carriage to move in said radial direction of said disk;
said magnetic circuit having a guide-rod holding part holding said guide rod,
said magnetic circuit being screwed on said frame in the state that said magnetic circuit holds said guide-rod at said guide-rod holding part.

4. A disk drive, comprising:
a frame;
a rotatable turntable adapted to support a disk;
a head carriage movable in a radial direction of said disk in a state that said disk is held on said turntable;
a head provided on said head carriage, said head conducting writing or reading of information to and from said disk;
a voice coil motor causing said head carriage to move in said radial direction of said disk within a predetermined range; and
a deformable shock absorber disposed in the vicinity of a said predetermined range, said deformable shock absorber being disposed so as to collide with said head carriage when said head carriage is moved beyond said predetermined range.

5. A disk drive as claimed in claim 4, wherein said deformable shock absorber is formed integrally with a holding member holding a guide shaft used to guide said head carriage in said radial direction.
